(19) United States
(12) Patent Application Publication
(10) Pub. No.: US 2022/0222745 A1
(43) Pub. Date: Jul. 14, 2022

(54) EXECUTION METHOD AND INFORMATION PROCESSING APPARATUS

(71) Applicant: FUJITSU LIMITED, Kawasaki-shi (JP)

(72) Inventors: Toshihiro Shimizu, Kawasaki (JP); Akihito Nakamura, Shinagawa (JP); Akihiro Kuwabara, Meguro (JP); Motohiro Kosaki, Kawasaki (JP)

(73) Assignee: FUJITSU LIMITED, Kawasaki-shi (JP)

(21) Appl. No.: 17/522,044

(22) Filed: Nov. 9, 2021

(30) Foreign Application Priority Data
Jan. 12, 2021 (JP) 2021-002887

(51) Int. Cl. G06Q 40/04

(52) U.S. Cl. CPC G06Q 40/04

(57) ABSTRACT

A non-transitory computer-readable recording medium stores an execution program for causing a computer to execute a process, the process includes setting information based on an order sequence and a number of orders regarding an order to a first array, and convolving a second array that corresponds to an order condition in which prices at multiple stages are set depending on the number of orders to the first set array using a Try-And-Clean-Up (TACU) algorithm.

### CROSS-REFERENCE TO RELATED APPLICATION

This application is based upon and claims the benefit of priority of the prior Japanese Patent Application No. 2021-2887, filed on Jan. 12, 2021, the entire contents of which are incorporated herein by reference.

### FIELD

The embodiment discussed herein is related to an execution method.

### BACKGROUND

In the securities market, establishment of a trade such as stock trading is referred to as “execution”. For example, a state where a condition of a user who has placed a sell order matches a condition of a user who has placed a buy order and transaction has been closed is referred to as an execution. In a case where a user places an order (sell order or buy order), there is a case where an order is placed under conditions such as a full-volume execution or a certain number of orders.

In the following description, the condition set to the order that is the minimum number of executions is referred to as the “minimum number of executions”. For example, in a case where there are a sell order of which the number of orders is “N” with a condition of the minimum number of executions “M” and a buy order of which the number of orders is equal to or more than “M”, transaction is closed.

FIG. 42 is a diagram illustrating a matching example between a sell order and a buy order to which the minimum number of executions is set. In the example illustrated in FIG. 42, orders Or1 and Or2 exist as sell orders. The order Or1 is an order of which the number of orders is “10” and the minimum number of executions is “5”. The order Or2 is an order of which the number of orders is “18” and the minimum number of executions is “13”.

Further, orders Or3, Or4, and Or5 exist as buy orders. The order Or3 is an order of which the number of orders is “14” and the minimum number of executions is “5”. The order Or4 is an order of which the number of orders is “21” and the minimum number of executions is “21”. The order Or5 is an order of which the number of orders is “10” and the minimum number of executions is “0”.

In a case where the number of executions is maximized according to the conditions of the sell orders and the buy orders illustrated in FIG. 42, the matching result is as follows. For example, the number of orders “5” are executed with the orders Or1 and Or3, and the number of orders “5” are executed with the orders Or1 and Or4. Furthermore, the number of orders “2” is executed with the orders Or2 and Or3, and the number of orders “16” is executed with the orders Or2 and Or4.

U.S. Patent Application Publication No. 2013/0018773, Japanese Laid-open Patent Publication No. 2008-234050, and Bussieck M., et al. “Fast Algorithms for the Maximum Convolution Problem” Operations Research Letters, Volume 15, Issue 3, April, pp 133-141, 1994 are disclosed as related art.

### SUMMARY

According to an aspect of the embodiment, a non-transitory computer-readable recording medium stores an execution program for causing a computer to execute a process, the process includes setting information based on an order sequence and a number of orders regarding an order to a first array, and convolving a second array that corresponds to an order condition in which prices at multiple stages are set depending on the number of orders to the first set array using a Try-And-Clean-Up (TACU) algorithm.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining processing on a first array_a in a case where a sell order is accepted (Part 1);

FIG. 2 is a diagram illustrating an example of a second array_a in a case where a buy order is accepted;

FIG. 3 is a diagram illustrating an example of processing for calculating the number of executions according to a first embodiment;

FIG. 4 is a diagram for explaining the processing on the first array_a in a case where a sell order is accepted (Part 2);

FIG. 5 is a diagram for explaining processing for specifying execution target orders according to the first embodiment (Part 1);

FIG. 6 is a diagram for explaining processing for specifying execution target orders according to the first embodiment (Part 2);

FIG. 7 is a diagram illustrating an exemplary functional configuration of an information processing apparatus according to the first embodiment;

FIG. 8 is a diagram illustrating an example of a data structure of a sell order table according to the first embodiment;

FIG. 9 is a diagram illustrating an example of a data structure of a buy order table according to the first embodiment;

FIG. 10 is a diagram illustrating an example of a data structure of first array information according to the first embodiment;

FIG. 11 is a diagram illustrating an example of a data structure of second array information according to the first embodiment;

FIG. 12 is a diagram illustrating an example of a data structure of execution result information according to the first embodiment;

FIG. 13 is a flowchart illustrating a processing procedure of the information processing apparatus according to the first embodiment;

FIG. 14 is a flowchart illustrating a processing procedure of order specification processing according to the first embodiment;

FIG. 15 is a flowchart illustrating a processing procedure of setting processing in a case where the minimum number of executions is guaranteed;

FIG. 16 is a diagram for explaining the setting processing in a case where the minimum number of executions is guaranteed (Part 1);

FIG. 17 is a diagram for explaining the setting processing in a case where the minimum number of executions is guaranteed (Part 2);

FIG. 18 is a diagram for explaining the setting processing in a case where the minimum number of executions is guaranteed (Part 3);

FIG. 19 is a diagram for explaining the setting processing in a case where the minimum number of executions is guaranteed (Part 4);

FIG. 20 is a diagram illustrating a matching example between sell orders and buy orders regarding a full-volume execution order for designating an amount of money

FIG. 21 is a diagram for explaining processing on an array_a in a case where a sell order is accepted (Part 1);

FIG. 22 is a diagram for explaining the processing on the array_a in a case where a sell order is accepted (Part 2);

FIG. 23 is a diagram for explaining processing on an array_b in a case where a buy order is accepted;

FIG. 24 is a diagram for explaining an example of processing for calculating the number of executions according to a second embodiment;

FIG. 25 is a diagram for explaining the processing on the array_a in a case where a sell order is accepted (Part 3);

FIG. 26 is a diagram for explaining processing for specifying execution target orders according to the second embodiment;

FIG. 27 is a diagram illustrating a configuration of an information processing apparatus according to the second embodiment;

FIG. 28 is a diagram illustrating an example of a data structure of a sell order table according to the second embodiment;

FIG. 29 is a diagram illustrating an example of a data structure of a buy order table according to the second embodiment;

FIG. 30 is a diagram illustrating an example of a data structure of first array information according to the second embodiment;

FIG. 31 is a diagram illustrating an example of a data structure of second array information according to the second embodiment;

FIG. 32 is a diagram illustrating an example of a data structure of execution result information according to the second embodiment;

FIG. 33 is a flowchart illustrating a processing procedure of the information processing apparatus according to the second embodiment;

FIG. 34 is a flowchart illustrating a processing procedure of array update processing of a sell order according to the second embodiment;

FIG. 35 is a flowchart illustrating a processing procedure of array update processing of a buy order according to the second embodiment;

FIG. 36 is a diagram for explaining processing according to a third embodiment;

FIG. 37 is a diagram illustrating an example of a data structure of array information according to the third embodiment;

FIG. 38 is a flowchart illustrating a processing procedure of an information processing apparatus according to the third embodiment;

FIG. 39 is a flowchart illustrating a processing procedure of array update processing of a sell order according to the third embodiment;

FIG. 40 is a flowchart illustrating a processing procedure of array update processing of a buy order according to the third embodiment;

FIG. 41 is a diagram illustrating an exemplary hardware configuration of a computer that implements functions similar to those of the information processing apparatuses according to the embodiments; and

FIG. 42 is a diagram illustrating a matching example between a sell order and a buy order to which the minimum number of executions is set.

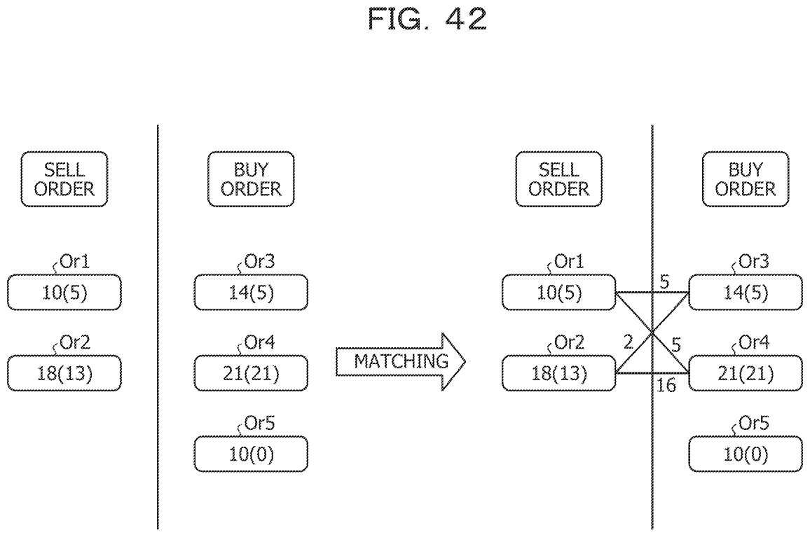

### DESCRIPTION OF EMBODIMENTS

The related art described above has a problem in that, in a case where an order condition in which prices at multiple stages are set depending on the number of executions is reflected to the number of orders (n) for arrays to which sell orders and buy orders are set, a calculation amount of O (n²) is needed, and a calculation cost is large.

Hereinafter, an execution method and an information processing apparatus according to embodiments will be described with reference to the drawings. Configurations having the same functions in the embodiment are denoted by the same reference signs, and redundant description will be omitted. Note that the execution method and the information processing apparatus to be described in the embodiment below are merely examples and do not limit the embodiment.

### First Embodiment

An information processing apparatus according to a first embodiment prepares a Bool (T, F) array so as to manage each of the sell orders or the buy orders, and specifies orders to be executed (execution target orders) such that the number of executions is maximized.

The Bool (T, F) array is referred to as an “array_a”. An index i that is equal to or more than zero is set to the array_a, and “T” or “F” is set to an element corresponding to the index i of the array_a. In a case where the element corresponding to the index i of the array_a is “T”, this means that there are orders with the number of orders i. In a case where the element corresponding to the index i of the array_a is “F”, this means that there is no order with the number of orders i. The letter “T” is an example of a registration symbol.

Array_a [i]=T indicates that the element corresponding to the index i of the array_a is “T”. Array_a [i]=F indicates that the element corresponding to the index i of the array_a is “F”.

In the present embodiment, an array_a that stores information regarding sell orders is referred to as a “first array_a”, and an array_a that stores information regarding buy orders is referred to as a “second array_a”.

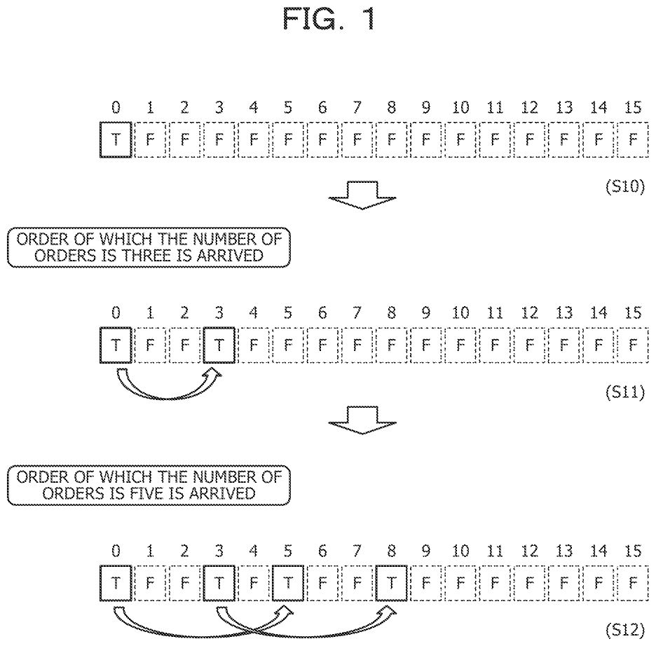

First, processing for calculating a maximum number of executions that may be matched by the information processing apparatus according to the first embodiment will be described. FIG. 1 is an explanatory diagram for explaining processing on the first array_a in a case where a sell order is accepted. In a case where a sell order with the number of orders x is accepted when first array_a [i]=T, the information processing apparatus sets the first array_a to first array_a [i+x]=T.

It is assumed that an initial state of the first array_a be as indicated in step S10. In the initial state of the first array_a, first array_a [0]=T, and all other elements of the first array_a are set to “F”.

In a case where a sell order of which the number of orders is three is accepted in this state, the state of the first array_a is as indicated in step S11. Because the first array_a is set as first array_a [0]=T, the information processing apparatus sets the first array_a to first array_a [0+3]=T.

In a case where an order of which the number of orders is five is further accepted in this state, the state of the first array_a is as indicated in step S12. Because the first array_a is set as first array_a [0]=T, the information processing apparatus sets the first array_a to first array_a [0+5]=T. Because the first array_a is set as first array_a [3]=T, the information processing apparatus sets the first array_a to first array_a [3+5]=T.

An index of which an element of the first array_a is T indicates an execution volume that may be matched. For example, in the state of the first array_a in step S12 in FIG. 1, an element of index i=8 is “T”, and the “8” is the number such that all the number of orders “3” and the number of orders “5” are executed.

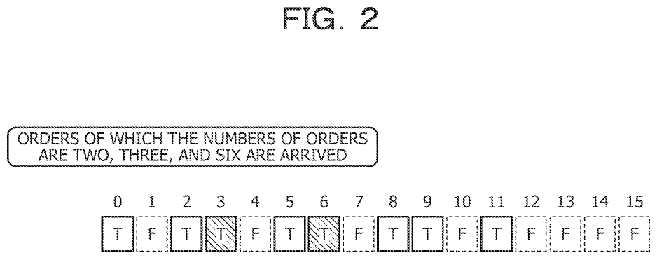

FIG. 2 illustrates an example of the second array_a in a case where a buy order is accepted. As in the processing on the first array_a in a case where the sell order is accepted described with reference to FIG. 1, in a case where a buy order with the number of orders x is accepted when second array_a [i]=T, the information processing apparatus sets the second array_a to second array_a [i+x]=T. In an initial state of the second array_a, second array_a [0]=T, and all other elements of the second array_a are set to “F”.

For example, in a case where a buy order of which the number of orders is two, a buy order of which the number of orders is three, and a buy order of which the number of orders is six are accepted in this order, the state of the second array_a is as indicated in FIG. 2. In other words, for example, second array_a [0]=T, second array_a [2]=T, second array_a [3]=T, second array_a [5]=T, second array_a [6]=T, second array_a [8]=T, second array_a [9]=T, and second array_a [11]=T, and other elements of the second array_a are set to “F”.

The information processing apparatus compares the first array_a of sell orders described with reference to FIG. 1 with the second array_a of buy orders described with reference to FIG. 2 and specifies the maximum execution volume that may be matched.

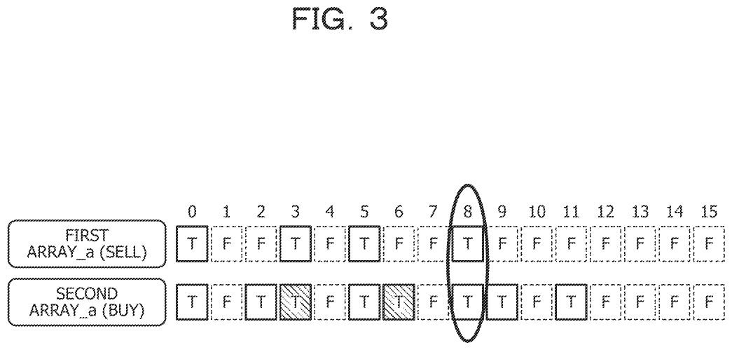

FIG. 3 is an explanatory diagram for explaining processing for calculating the number of executions according to the first embodiment. The information processing apparatus compares the first array_a with the second array_a and specifies the largest index among indexes of which both of the element of the first array_a and the element of the second array_a are “T” as the maximum number of executions. In the example illustrated in FIG. 3, since the largest index among the indexes of which both of the element of the first array_a and the element of the second array_a are “T” is “8”, the information processing apparatus calculates “8” as the maximum execution volume that may be matched.

Subsequently, processing for specifying execution target orders by the information processing apparatus according to the first embodiment will be described. The information processing apparatus may specify execution target orders by registering auxiliary information that indicates an order acceptance sequence (order sequence) and a volume (the number of orders) for each index in a case where the information processing apparatus accepts an order and sets “T” to the relevant element of the array_a for the first time.

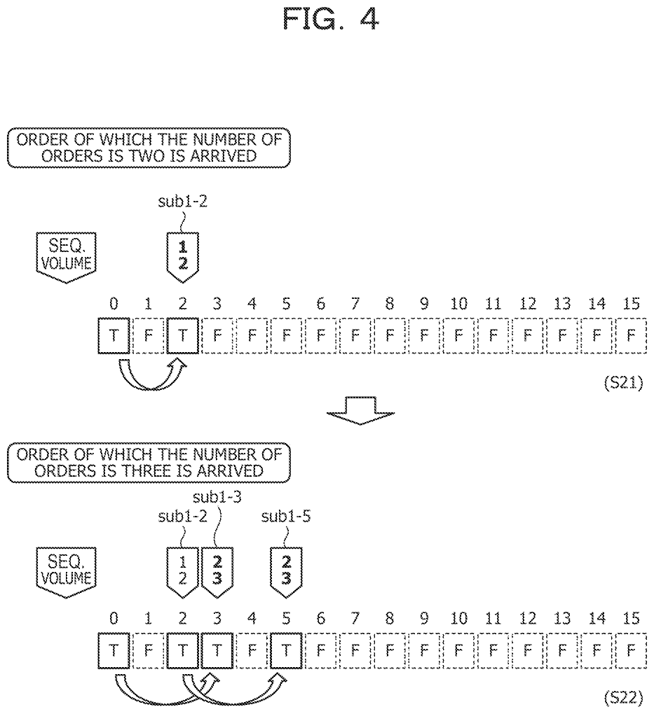

FIG. 4 is an explanatory diagram for explaining processing on the first array_a in a case where a sell order is accepted. In FIG. 4, the initial state of the first array_a is not illustrated. However, the initial state of the first array_a corresponds to the state of the first array_a in step S10 described with reference to FIG. 1. The information processing apparatus does not add the auxiliary information to the element that is set as “T” in the initial state. Note that an order acceptance sequence of a sell order corresponds to a “first order sequence”, and the number of orders of sell orders corresponds to a “first number of orders”.

In a case where a sell order of which the number of orders is two is accepted first (order acceptance sequence=1), the state of the first array_a is as indicated in step S21. Since the first array_a in the initial state is set as first array_a [0]=T, the information processing apparatus sets the first array_a to first array_a [0+2]=T. Furthermore, auxiliary information sub1-2 is set for index i=2. A sequence (denoted by “SEQ.” in the drawings) “1” and a volume “2” are set to the auxiliary information sub1-2.

Subsequently (order acceptance sequence=2), in a case where a sell order of which the number of orders is three is accepted, the state of the first array_a is as indicated in step S22. Because the first array_a is set as first array_a [0]=T, the information processing apparatus sets the first array_a to first array_a [0+3]=T and registers auxiliary information sub1-3 for index i=3. A sequence “2” and a volume “3” are set to the auxiliary information sub1-3.

Because the first array_a is set as first array_a [2]=T, the information processing apparatus sets the first array_a to first array_a [2+3]=T and registers auxiliary information sub1-5 for index i=5. A sequence “2” and a volume “3” are set to the auxiliary information sub1-5.

Although not illustrated, in a case of accepting a buy order, the information processing apparatus sets “T” to the element of the second array_a and registers auxiliary information for an index as in FIG. 4. Note that an order acceptance sequence of a buy order corresponds to a “second order sequence”, and the number of orders of buy orders corresponds to a “second number of orders”.

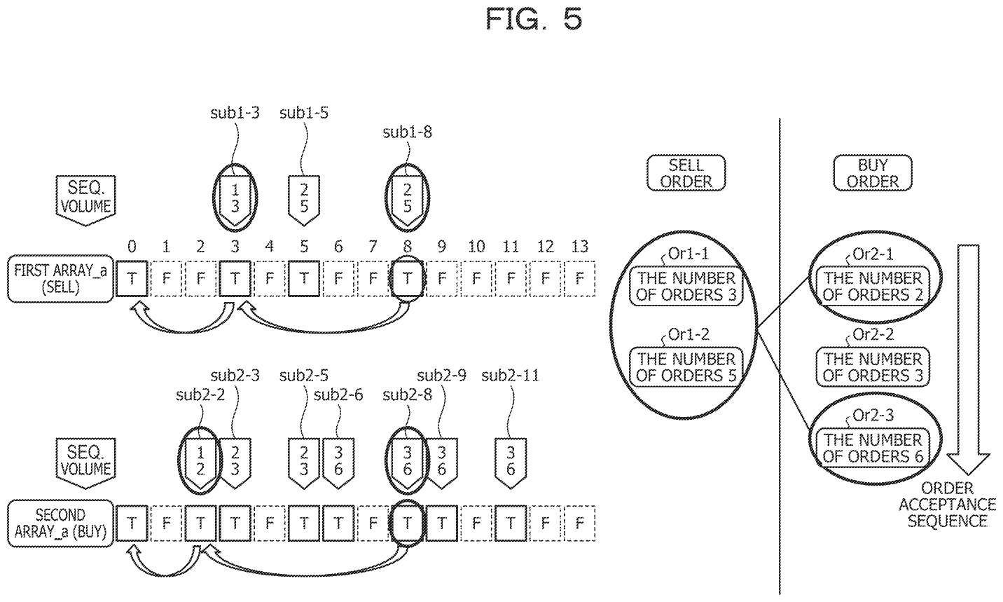

FIG. 5 is an explanatory diagram for explaining processing for specifying execution target orders according to the first embodiment. In FIG. 5, the information processing apparatus sequentially accepts orders Or1-1 and Or1-2 as sell orders. The order Or1-1 is an order of which the number of orders is “3”. The order Or1-2 is an order of which the number of orders is “5”. The information processing apparatus sequentially accepts orders Or2-1, Or2-2, and Or2-3 as buy orders. The order Or2-1 is an order of which the number of orders is “2”. The order Or2-2 is an order of which the number of orders is “3”. The order Or2-3 is an order of which the number of orders is “6”.

When sequentially accepting the orders Or1-1 and Or1-2, the information processing apparatus sets the first array_a to a state as illustrated in FIG. 5 by executing the processing on the first array_a in a case where a sell order is accepted. The elements of the indexes i=0, 3, 5, and 8 of the first array_a are set to “T”, and other elements of the first array_a are set to “F”. “T” of index i=0 is set in the initial state.

The information processing apparatus sets the auxiliary information sub1-3 to index i=3 of the first array_a. A sequence “1” and a volume “3” are set to the auxiliary information sub1-3. The information processing apparatus sets auxiliary information sub1-5 to index i=5 of the first array_a. A sequence “2” and a volume “5” are set to the auxiliary information sub1-5. The information processing apparatus sets auxiliary information sub1-8 to index i=8 of the first array_a. A sequence “2” and a volume “5” are set to the auxiliary information sub1-8.

When sequentially accepting the orders Or2-1, Or2-2, and Or2-3, the information processing apparatus sets the second array_a to a state as illustrated in FIG. 5 by executing the processing on the second array_a in a case where a buy order is accepted. The elements of the indexes i=0, 2, 3, 5, 6, 8, 9, and 11 of the second array_a are set to “T”, and other elements of the second array_a are set to “F”. “T” of index i=0 is set in the initial state.

The information processing apparatus sets auxiliary information sub2-2 to index i=2 of the second array_a. A sequence “1” and a volume “2” are set to the auxiliary information sub2-2. The information processing apparatus sets auxiliary information sub2-3 to index i=3 of the second array_a. A sequence “2” and a volume “3” are set to the auxiliary information sub2-3. The information processing apparatus sets auxiliary information sub2-5 to index i=5 of the second array_a. A sequence “2” and a volume “3” are set to the auxiliary information sub2-5.

The information processing apparatus sets auxiliary information sub2-6 to index i=6 of the second array_a. A sequence “3” and a volume “6” are set to the auxiliary information sub2-6. The information processing apparatus sets auxiliary information sub2-8 to index i=8 of the second array_a. A sequence “3” and a volume “6” are set to the auxiliary information sub2-8. The information processing apparatus sets auxiliary information sub2-9 to index i=9 of the second array_a. A sequence “3” and a volume “6” are set to the auxiliary information sub2-9. The information processing apparatus sets auxiliary information sub2-11 to index i=11 of the second array_a. A sequence “3” and a volume “6” are set to the auxiliary information sub2-11.

The information processing apparatus compares the first array_a with the second array_a and calculates the largest index among the indexes of which both of the element of the first array_a and the element of the second array_a are set to “T” as the number of executions. In the example illustrated in FIG. 5, the largest index of the indexes of which both of the element of the first array_a and the element of the second array_a are set to “T” is index i=8. Therefore, the information processing apparatus sets “8” to the number of executions.

After calculating the number of executions, the information processing apparatus specifies execution target orders on the basis of the auxiliary information set to each array_a. In a case where an execution is made with the number of executions i₀, the information processing apparatus sets an initial value of the index as i=i₀ and repeatedly executes the following processing until i=0 is satisfied.

The processing repeated by the information processing apparatus is the following processing. The information processing apparatus sets an order with array_a [i]=T as an execution target. Next, the information processing apparatus specifies a volume a included in auxiliary information set to array_a [i] and updates the index i according to i=i−a.

Processing for specifying a sell order to be executed by the information processing apparatus on the basis of the “first array_a” in FIG. 5 will be described.

The information processing apparatus sets an order corresponding to the auxiliary information sub1-8 set for index i=8, which corresponds to the number of executions “8”, as an execution target. The auxiliary information sub1-8 corresponds to the order Or1-2 of which the sequence is “2” and the volume is “5”. The information processing apparatus acquires a volume a=5 included in the auxiliary information sub1-8 and updates the index i to index i=8−5=3.

The information processing apparatus sets an order corresponding to the auxiliary information sub1-3 set for index i=3 as an execution target. The auxiliary information sub1-3 corresponds to the order Or1-1 of which the sequence is “1” and the volume is “3”. The information processing apparatus acquires a volume a=3 included in the auxiliary information sub1-3 and updates the index i to index i=3−3=0. Because index i=0, the information processing apparatus ends the processing.

Processing for specifying a buy order to be executed by the information processing apparatus on the basis of the “second array_a” in FIG. 5 will be described.

The information processing apparatus sets an order corresponding to the auxiliary information sub2-8 set for index i=8, which corresponds to the number of executions “8”, as an execution target. The auxiliary information sub2-8 corresponds to the order Or2-3 of which the sequence is “3” and the volume is “6”. The information processing apparatus acquires a volume a=6 included in the auxiliary information sub2-8 and updates the index i to index i=8−6=2.

The information processing apparatus sets an order corresponding to the auxiliary information sub2-2 set for index i=2 as an execution target. The auxiliary information sub2-2 corresponds to the order Or2-1 of which the sequence is “1” and the volume is “2”. The information processing apparatus acquires a volume a=2 included in the auxiliary information sub2-2 and updates the index i to index i=2−2=0. Because index i=0, the information processing apparatus ends the processing.

By the processing described above, the sell orders Or1-1 and Or1-2 and the buy orders Or2-1 and Or2-3 are specified to be the execution targets.

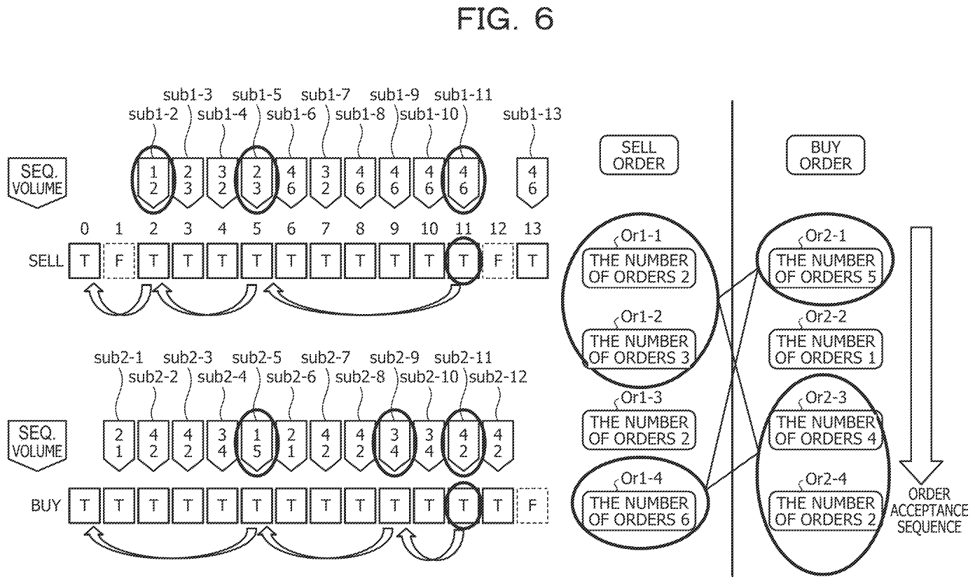

FIG. 6 is a diagram for explaining the processing for specifying execution target orders according to the first embodiment. In FIG. 6, the information processing apparatus sequentially accepts orders Or1-1, Or1-2, Or1-3, and Or1-4 as sell orders. The order Or1-1 is an order of which the number of orders is “2”. The order Or1-2 is an order of which the number of orders is “3”. The order Or1-3 is an order of which the number of orders is “2”. The order Or1-4 is an order of which the number of orders is “6”.

The information processing apparatus sequentially accepts orders Or2-1, Or2-2, Or2-3, and Or2-4 as buy orders. The order Or2-1 is an order of which the number of orders is “5”. The order Or2-2 is an order of which the number of orders is “1”. The order Or2-3 is an order of which the number of orders is “4”. The order Or2-4 is an order of which the number of orders is “2”.

When sequentially accepting the orders Or1-1, Or1-2, Or1-3, and Or1-4, the information processing apparatus sets the first array_a to a state as illustrated in FIG. 6 by executing processing on the first array_a in a case where a buy order is accepted. The elements of the indexes i=0, 2 to 11, and 13 of the first array_a are set to “T”, and other elements are set to “F”. “T” of index i=0 is set in the initial state.

The information processing apparatus sets auxiliary information sub1-2 to index i=2 of the first array_a. A sequence “1” and a volume “2” are set to the auxiliary information sub1-2. The information processing apparatus sets the auxiliary information sub1-3 to index i=3 of the first array_a. A sequence “2” and a volume “3” are set to the auxiliary information sub1-3. The information processing apparatus sets auxiliary information sub1-4 to index i=4 of the first array_a. A sequence “3” and a volume “2” are set to the auxiliary information sub1-4.

The information processing apparatus sets auxiliary information sub1-5 to index i=5 of the first array_a. A sequence “2” and a volume “3” are set to the auxiliary information sub1-5. The information processing apparatus sets auxiliary information sub1-6 to index i=6 of the first array_a. A sequence “4” and a volume “6” are set to the auxiliary information sub1-6. The information processing apparatus sets auxiliary information sub1-7 to index i=7 of the first array_a. A sequence “3” and a volume “2” are set to the auxiliary information sub1-7.

The information processing apparatus sets auxiliary information sub1-8 to index i=8 of the first array_a. A sequence “4” and a volume “6” are set to the auxiliary information sub1-8. The information processing apparatus sets auxiliary information sub1-9 to index i=9 of the first array_a. A sequence “4” and a volume “6” are set to the auxiliary information sub1-9. The information processing apparatus sets auxiliary information sub1-10 to index i=10 of the first array_a. A sequence “4” and a volume “6” are set to the auxiliary information sub1-10.

The information processing apparatus sets auxiliary information sub1-11 to index i=11 of the first array_a. A sequence “4” and a volume “6” are set to the auxiliary information sub1-11. The information processing apparatus sets auxiliary information sub1-13 to index i=13 of the first array_a. A sequence “4” and a volume “6” are set to the auxiliary information sub1-13.

When sequentially accepting the orders Or2-1, Or2-2, Or2-3, and Or2-4, the information processing apparatus sets the second array_a to a state as illustrated in FIG. 6 by executing processing on the second array_a in a case where a buy order is accepted. The elements of the indexes i=0 to 12 of the second array_a are set to “T”, and other elements are set to “F”. “T” of index i=0 is set in the initial state.

The information processing apparatus sets auxiliary information sub2-1 to index i=1 of the second array_a. A sequence “2” and a volume “1” are set to the auxiliary information sub2-1. The information processing apparatus sets auxiliary information sub2-2 to index i=2 of the second array_a. A sequence “4” and a volume “2” are set to the auxiliary information sub2-2. The information processing apparatus sets auxiliary information sub2-3 to index i=3 of the second array_a. A sequence “4” and a volume “2” are set to the auxiliary information sub2-3.

The information processing apparatus sets auxiliary information sub2-4 to index i=4 of the second array_a. A sequence “3” and a volume “4” are set to the auxiliary information sub2-4. The information processing apparatus sets auxiliary information sub2-5 to index i=5 of the second array_a. A sequence “1” and a volume “5” are set to the auxiliary information sub2-5. The information processing apparatus sets auxiliary information sub2-6 to index i=6 of the second array_a. A sequence “2” and a volume “1” are set to the auxiliary information sub2-6.

The information processing apparatus sets auxiliary information sub2-7 to index i=7 of the second array_a. A sequence “4” and a volume “2” are set to the auxiliary information sub2-7. The information processing apparatus sets auxiliary information sub2-8 to index i=8 of the second array_a. A sequence “4” and a volume “2” are set to the auxiliary information sub2-8. The information processing apparatus sets auxiliary information sub2-9 to index i=9 of the second array_a. A sequence “3” and a volume “4” are set to the auxiliary information sub2-9.

The information processing apparatus sets auxiliary information sub2-10 to index i=10 of the second array_a. A sequence “3” and a volume “4” are set to the auxiliary information sub2-10. The information processing apparatus sets auxiliary information sub2-11 to index i=11 of the second array_a. A sequence “4” and a volume “2” are set to the auxiliary information sub2-11. The information processing apparatus sets auxiliary information sub2-12 to index i=12 of the second array_a. A sequence “4” and a volume “2” are set to the auxiliary information sub2-12.

The information processing apparatus compares the first array_a with the second array_a and calculates the largest index among the indexes of which both of the element of the first array_a and the element of the second array_a are set to “T” as the number of executions. In the example illustrated in FIG. 6, the largest index of the indexes of which both of the element of the first array_a and the element of the second array_a are set to “T” is index i=11. Therefore, the information processing apparatus sets the number of executions to “11”.

Processing for specifying a sell order to be executed by the information processing apparatus will be described on the basis of the “first array_a” in FIG. 6.

The information processing apparatus sets an order corresponding to the auxiliary information sub1-11 set for index i=11 corresponding to the number of executions “11” as an execution target. The auxiliary information 1-11 corresponds to the order Or1-4 of which the sequence is “4” and the volume is “6”. The information processing apparatus acquires a volume a=6 included in the auxiliary information sub1-11 and updates the index i to index i=11−6=5.

The information processing apparatus sets an order corresponding to the auxiliary information sub1-5 set for index i=5 as an execution target. The auxiliary information 1-5 corresponds to the order Or1-2 of which the sequence is “2” and the volume is “3”. The information processing apparatus acquires a volume a=3 included in the auxiliary information sub1-5 and updates the index i to index i=5−3=2.

The information processing apparatus sets an order corresponding to the auxiliary information sub1-2 set for index i=2 as an execution target. The auxiliary information 1-2 corresponds to the order Or1-1 of which the sequence is “1” and the volume is “2”. The information processing apparatus acquires a volume a=2 included in the auxiliary information sub1-2 and updates the index i to index i=2−2=0. Because index i=0, the information processing apparatus ends the processing.

Processing for specifying a buy order to be executed by the information processing apparatus will be described on the basis of the “second array_a” in FIG. 6.

The information processing apparatus sets an order corresponding to the auxiliary information sub2-11 set for index i=11 corresponding to the number of executions “11” as an execution target. The auxiliary information 2-11 corresponds to the order Or2-4 of which the sequence is “4” and the volume is “2”. The information processing apparatus acquires a volume a=2 included in the auxiliary information sub2-11 and updates the index i to index i=11−2=9.

The information processing apparatus sets an order corresponding to the auxiliary information sub2-9 set for index i=9 as an execution target. The auxiliary information 2-9 corresponds to the order Or2-3 of which the sequence is “3” and the volume is “4”. The information processing apparatus acquires a volume a=4 included in the auxiliary information sub2-9 and updates the index i to index i=9−4=5.

The information processing apparatus sets an order corresponding to the auxiliary information sub2-5 set for index i=5 as an execution target. The auxiliary information 2-5 corresponds to the order Or2-1 of which the sequence is “1” and the volume is “5”. The information processing apparatus acquires a volume a=5 included in the auxiliary information sub2-1 and updates the index i to index i=5−5=0. Because index i=0, the information processing apparatus ends the processing.

By the above processing, the sell orders Or1-1, Or1-2, and Or1-4 and the buy orders Or2-1, Or2-3, and Or2-4 are specified to be the execution targets.

As described above, the information processing apparatus according to the first embodiment sets information based on the order sequence and the number of orders of sell orders to the first array_a in a case where the sell orders are accepted and sets information based on the order sequence and the number of orders of buy orders to the second array_a in a case where the buy orders are accepted. The information processing apparatus calculates the maximum number of executions on the basis of the information set to the first array_a and the information set to the second array_a. Then, the information processing apparatus specifies execution target orders on the basis of the calculated maximum number of executions, the information set to the first array_a, and the information set to the second array_a. In other words, for example, according to the information processing apparatus according to the first embodiment, it is possible to specify the execution target orders of which the number of executions is maximized.

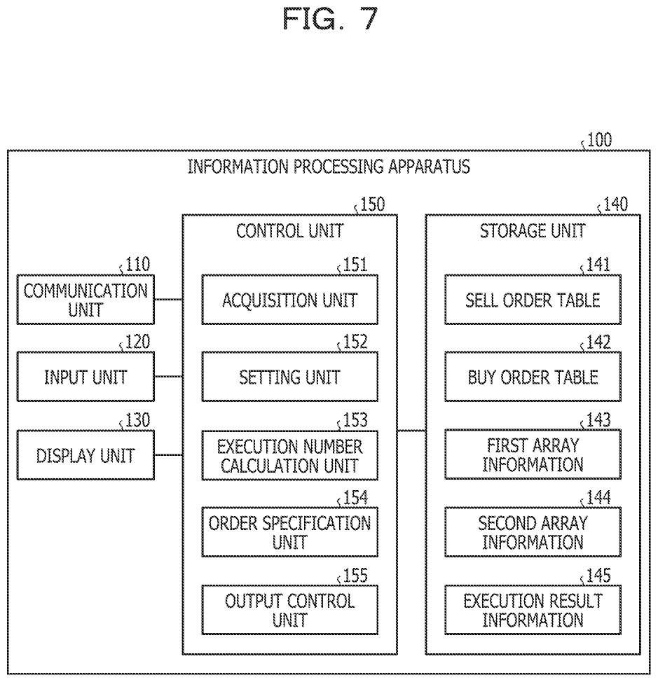

Next, an exemplary functional configuration of the information processing apparatus that performs processing described with reference to FIGS. 1 to 6. FIG. 7 is a block diagram illustrating an exemplary functional configuration of the information processing apparatus according to the first embodiment. As illustrated in FIG. 7, an information processing apparatus 100 includes a communication unit 110, an input unit 120, a display unit 130, a storage unit 140, and a control unit 150.

The communication unit 110 is wired or wirelessly coupled to an external device or the like and exchanges information with the external device or the like. For example, the communication unit 110 is implemented by a network interface card (NIC) or the like. The communication unit 110 may be coupled to a network (not illustrated). For example, the communication unit 110 receives information regarding a sell order table 141 including information regarding sell orders, information regarding a buy order table 142 including information regarding buy orders, or the like from the external device. For example, the external device corresponds to a server that manages buying and selling of stocks and executes various types of processing on execution target orders.

The input unit 120 is an input device that inputs various types of information to the information processing apparatus 100. The input unit 120 corresponds to a keyboard, a mouse, a touch panel, and the like.

The display unit 130 is a display device that displays information output from the control unit 150. The display unit 130 corresponds to a liquid crystal display, an organic electro luminescence (EL) display, a touch panel, or the like.

The storage unit 140 includes the sell order table 141, the buy order table 142, first array information 143, second array information 144, and execution result information 145. The storage unit 140 is implemented, for example, by a semiconductor memory element such as a random access memory (RAM) or a flash memory, or a storage device such as a hard disk or an optical disk.

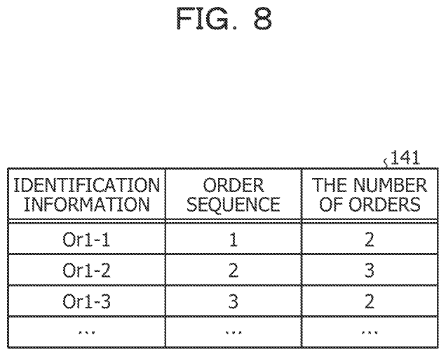

The sell order table 141 is a table that holds an order sequence and the number of orders of a sell order. FIG. 8 is an explanatory diagram illustrating an example of a data structure of the sell order table 141 according to the first embodiment. As illustrated in FIG. 8, the sell order table 141 associates identification information, the order sequence, and the number of orders. The identification information is information that uniquely identifies an order. The order sequence is a sequence of an accepted sell order. The number of orders is the number of sell orders.

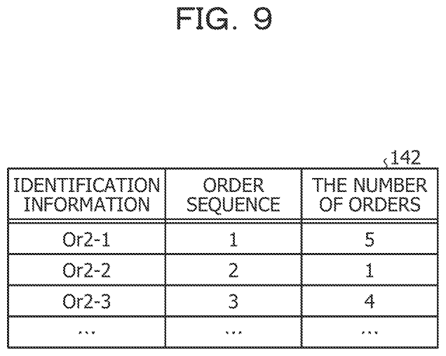

The buy order table 142 is a table that holds an order sequence and the number of orders of a buy order. FIG. 9 is an explanatory diagram illustrating an example of a data structure of the buy order table 142 according to the first embodiment. As illustrated in FIG. 9, the buy order table 142 associates identification information, the order sequence, and the number of orders. The identification information is information that uniquely identifies an order. The order sequence is a sequence of an accepted buy order. The number of orders is the number of buy orders.

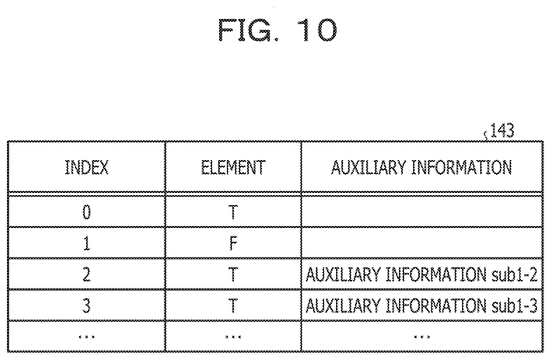

The first array information 143 is array information that holds information based on an order sequence and the number of orders regarding sell orders. The first array information 143 corresponds to the first array_a described above. FIG. 10 is a diagram illustrating an example of a data structure of the first array information 143 according to the first embodiment. As illustrated in FIG. 10, the first array information 143 includes an index, an element, and auxiliary information. The index corresponds to the index i of the first array_a. The element is an element of the first array_a, and “T” or “F” is set. The auxiliary information is information indicating an order acceptance sequence (order sequence) and a volume (the number of orders).

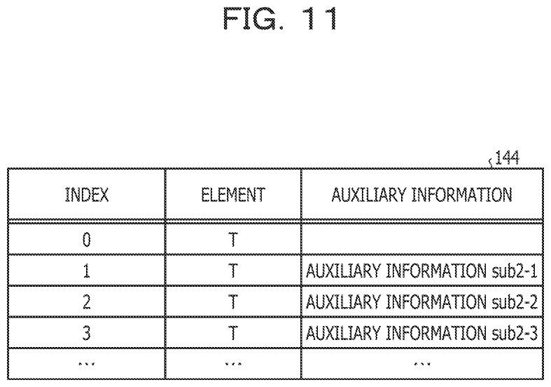

The second array information 144 is array information that holds information based on an order sequence and the number of orders regarding buy orders. The second array information 144 corresponds to the second array_a described above. FIG. 11 is a diagram illustrating an example of a data structure of the second array information 144 according to the first embodiment. As illustrated in FIG. 11, the second array information 144 includes an index, an element, and auxiliary information. The index corresponds to the index i of the second array_a. The element is an element of the second array_a, and “T” or “F” is set. The auxiliary information is information indicating an order acceptance sequence (order sequence) and a volume (the number of orders).

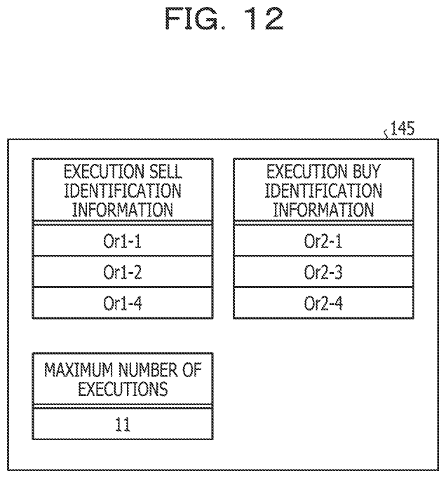

The execution result information 145 holds information regarding the maximum number of executions and execution target orders. FIG. 12 is an explanatory diagram illustrating an example of a data structure of the execution result information 145 according to the first embodiment. As illustrated in FIG. 12, the execution result information 145 includes execution sell identification information, execution buy identification information, and the maximum number of executions. The execution sell identification information is information that identifies a sell order to be executed. The execution buy identification information is information that identifies a buy order to be executed. The maximum number of executions indicates the largest number of executions.

Returning to description of FIG. 7, the control unit 150 includes an acquisition unit 151, a setting unit 152, an execution number calculation unit 153, an order specification unit 154, and an output control unit 155. The control unit 150 is implemented by, for example, a central processing unit (CPU) or a micro processing unit (MPU). Furthermore, for example, the control unit 150 may be implemented by an integrated circuit such as an application specific integrated circuit (ASIC) or a field programmable gate array (FPGA).

The acquisition unit 151 is a processing unit that accepts an order of which a condition of the number of executions is designated. In a case of acquiring data of the sell order table 141 from an external device or the like, the acquisition unit 151 stores the data of the sell order table 141 in the storage unit 140. The acquisition unit 151 may individually acquire sell orders sequentially and register information regarding the acquired sell orders to the sell order table 141.

In a case of acquiring data of the buy order table 142 from an external device or the like, the acquisition unit 151 stores the data of the buy order table 142 in the storage unit 140. The acquisition unit 151 may individually acquire buy orders sequentially and register information regarding the acquired buy orders to the buy order table 142.

The setting unit 152 sets information based on the order sequence and the number of orders regarding the sell orders to the first array information 143 (first array_a) on the basis of the sell order table 141. Furthermore, the setting unit 152 sets information based on the order sequence and the number of orders regarding the buy orders to the second array information 144 (second array_a) on the basis of the buy order table 142.

Processing for setting the information based on the order sequence and the number of orders regarding the sell orders to the first array information 143 on the basis of the sell order table 141 by the setting unit 152 corresponds to the processing on the first array_a described with reference to FIG. 4. In a case where a sell order with the number of orders x is accepted in first array_a [i]=T, the setting unit 152 sets the first array_a to first array_a [i+x]=T.

For example, the setting unit 152 sets an element of an index i=i+x of the first array information 143 to “T” and sets the auxiliary information to which the order acceptance sequence and the volume are set as auxiliary information of index i=i+x. The setting unit 152 repeatedly executes the above processing on each sell order of the sell order table 141.

Processing for setting the information based on the order sequence and the number of orders regarding the buy orders to the second array information 144 on the basis of the buy order table 142 by the setting unit 152 corresponds to processing described with reference to FIG. 4 in which the first array_a is replaced with the second array_a. In a case where a sell order with the number of orders x is accepted in second array_a [i]=T, the setting unit 152 sets the second array_a to second array_a [i+x]=T.

For example, the setting unit 152 sets an element of an index i=i+x of the second array information 144 to “T” and sets the auxiliary information to which the order acceptance sequence and the volume are set as auxiliary information of index i=i+x. The setting unit 152 repeatedly executes the above processing on each buy order of the buy order table 142.

The execution number calculation unit 153 is a processing unit that calculates the maximum number of executions of sell orders and buy orders on the basis of the first array information 143 and the second array information 144. The processing of the execution number calculation unit 153 corresponds to the processing described with reference to FIG. 3. The execution number calculation unit 153 compares the first array information 143 and the second array information 144 and calculates the largest index among the indexes of which both of the element of the first array information 143 and the element of the second array information 144 are set to “T” as the maximum number of executions. The execution number calculation unit 153 registers the calculated maximum number of executions to the execution result information 145.

The execution number calculation unit 153 may execute the above processing at a timing when an instruction for determining the number of executions is accepted from the input unit 120 or an external device or the like. The execution number calculation unit 153 may execute the above processing at a timing when a predetermined time elapses after the setting unit 152 sets the first array information 143 and the second array information 144.

The order specification unit 154 is a processing unit that specifies orders to be executed on the basis of the maximum number of executions, the first array information 143, and the second array information 144. The processing of the order specification unit 154 corresponds to the processing described with reference to FIGS. 5 and 6. In a case where an execution is made with the number of executions (the maximum number of executions) i₀, the order specification unit 154 sets an initial value of index i=i₀ and repeatedly executes the following processing until i=0 is satisfied.

The processing repeated by the order specification unit 154 is the following processing. The order specification unit 154 sets an order with array_a [i]=T as an execution target. Next, the order specification unit 154 specifies a volume a included in auxiliary information set to array_a [i] and updates the index i according to i=i−a.

For example, as described with reference to FIG. 5, the order specification unit 154 specifies the identification information Or1-1 and Or1-2 of orders to be executed by executing the above processing on the first array_a (first array information 143). The order specification unit 154 specifies identification information Or2-1 and Or2-3 of orders to be executed by executing the above processing on the second array_a (second array information 144).

As described with reference to FIG. 6, the order specification unit 154 specifies the identification information Or1-1, Or1-2, and Or1-4 of orders to be executed by executing the above processing on the first array_a (first array information 143). The order specification unit 154 specifies identification information Or2-1, Or2-3, and Or2-4 of orders to be executed by executing the above processing on the second array_a (second array information 144).

Next, the order specification unit 154 registers the identification information of the execution target orders specified by executing the above processing to the execution result information 145. Furthermore, the execution processing unit 154 acquires information regarding the execution target orders from the sell order table 141 or the buy order table 142 and notifies the operation unit 153 of the acquired information.

The output control unit 155 is a processing unit that outputs the execution result information 145 to the display unit 130 and makes the display unit 130 display the execution result information 145. The output control unit 155 may transmit the execution result information 145 to an external device and request various types of execution processing.

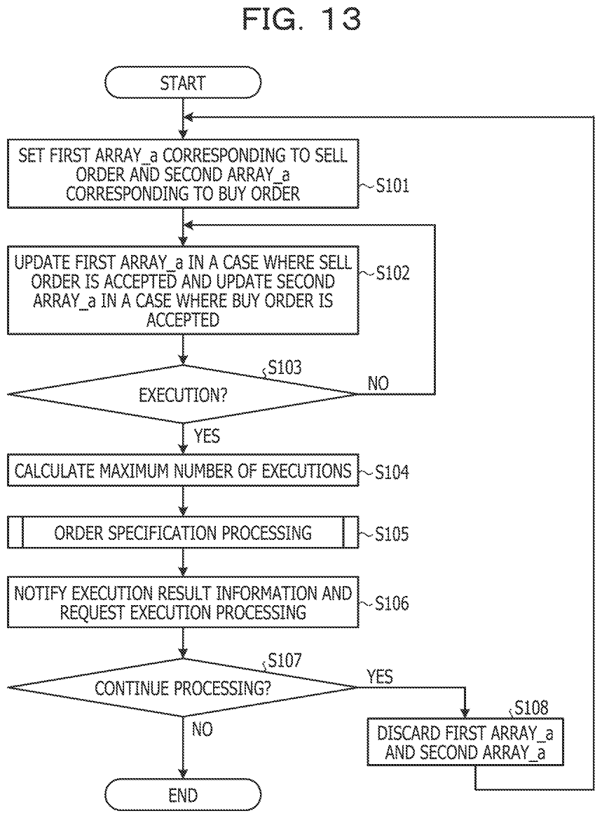

Next, an example of a processing procedure of the information processing apparatus 100 according to the first embodiment will be described. FIG. 13 is a flowchart illustrating the processing procedure of the information processing apparatus 100 according to the first embodiment. As illustrated in FIG. 13, the setting unit 152 of the information processing apparatus 100 sets a first array_a regarding sell orders and a second array_a regarding buy orders (step S101). The information regarding the first array_a corresponds to the first array information 143. The information regarding the second array_a corresponds to the second array information 144.

The setting unit 152 updates the first array_a in a case where a sell order is accepted and updates the second array_a in a case where a buy order is accepted (step S102). In a case where no orders are executed (step S103, No), the information processing apparatus 100 proceeds to step S102. In a case where orders are executed (step S103, Yes), the information processing apparatus 100 proceeds to step S104.

The execution number calculation unit 153 of the information processing apparatus 100 calculates the maximum number of executions (step S104). The order specification unit 154 of the information processing apparatus 100 executes order specification processing (step S105).

The output control unit 155 of the information processing apparatus 100 notifies an external device or the like of execution result information and requests execution processing (step S106). In a case where the processing is continued (step S107, Yes), the information processing apparatus 100 proceeds to step S108. The setting unit 152 discards the first array_a and the second array_a (step S108) and proceeds to step S101.

On the other hand, in a case where the processing is not continued (step S107, No), the information processing apparatus 100 ends the processing.

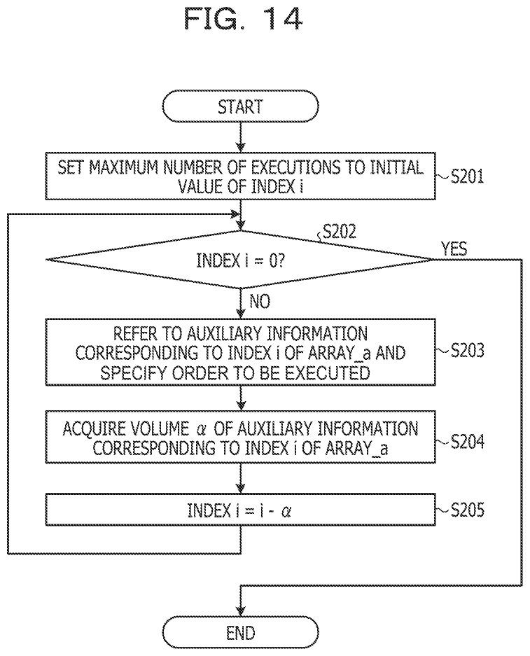

Next, the processing procedure of the order specification processing described in step S105 in FIG. 13 will be described. FIG. 14 is a flowchart illustrating the processing procedure of the order specification processing according to the first embodiment. The order specification unit 154 of the information processing apparatus 100 sets the maximum number of executions to an initial value of the index i (step S201).

In a case where index i=0 (step S202, Yes), the order specification unit 154 ends the order specification processing. In a case where index i=0 is not satisfied (step S202, No), the order specification unit 154 proceeds to step S203.

The order specification unit 154 refers to the auxiliary information corresponding to the index i of the array_a and specifies an order to be executed (step S203). The order specification unit 154 acquires a volume a of the auxiliary information corresponding to the index i of the array_a (step S204).

The order specification unit 154 updates the index i according to a value obtained by subtracting a from the index i (step S205) and proceeds to step S202.

The order specification unit 154 executes the processing illustrated in FIG. 14 on the first array_a so as to specify a sell order to be executed. The order specification unit 154 executes the processing illustrated in FIG. 14 on the second array_a so as to specify a buy order to be executed.

Next, effects of the information processing apparatus 100 according to the first embodiment will be described. The information processing apparatus 100 sets information based on the order sequence and the number of orders of a sell order to the first array_a in a case where the sell order is accepted and sets information based on the order sequence and the number of orders of a buy order to the second array_a in a case where the buy order is accepted. The information processing apparatus 100 calculates the maximum number of executions on the basis of the information set to the first array_a and the information set to the second array_a. Then, the information processing apparatus 100 specifies orders to be executed on the basis of the calculated maximum number of executions, the information set to the first array_a, and the information set to the second array_a. In other words, for example, according to the information processing apparatus 100 according to the first embodiment, it is possible to specify orders to be execution targets of which the number of executions is maximized.

In a case where information regarding a sell order sequence and the number of orders is accepted, the information processing apparatus 100 sets the registration symbol “T” to the element of the index of the first array_a specified on the basis of the number of orders and sets auxiliary information of the order sequence and the number of orders in association with the index. In a case where information regarding a buy order sequence and the number of orders is accepted, the information processing apparatus 100 sets the registration symbol “T” to the element of the index of the second array_a specified on the basis of the number of orders and sets auxiliary information of the order sequence and the number of orders in association with the index. As a result, by comparing the first array_a and the second array_a, it is possible to easily specify the maximum number of executions. Furthermore, the auxiliary information is used to trace the indexes of the first array_a and the second array_a, and it is possible to specify the orders to be executed.

By the way, regarding the processing of the information processing apparatus 100 described above, a case where full-volume execution is guaranteed has been described. However, in a case where the minimum number of executions is guaranteed, it is possible to similarly specify the maximum number of executions. In the following description, processing for specifying the maximum number of executions by the information processing apparatus 100 in a case of accepting an order for which the minimum number of executions is designated will be described.

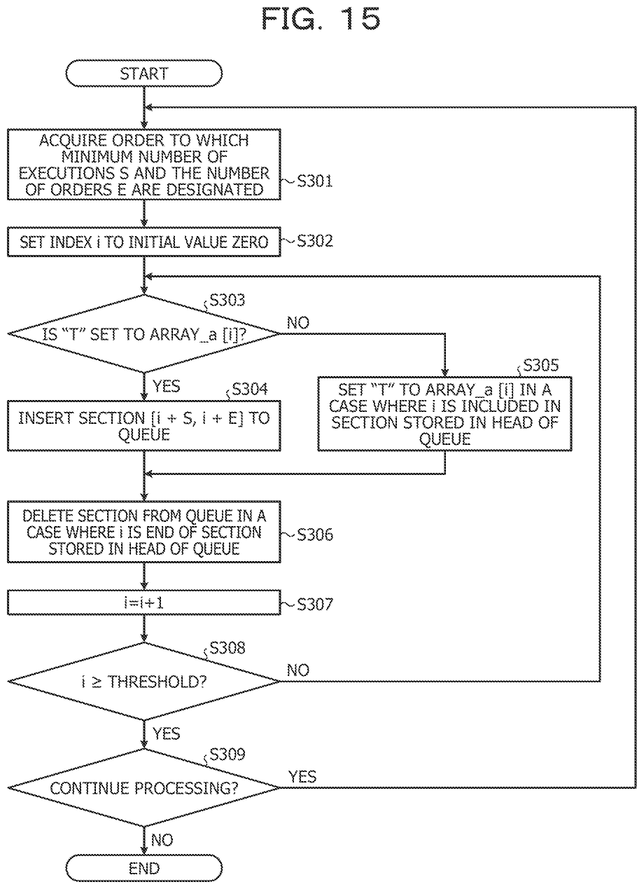

The information processing apparatus 100 prepares a queue for storing a section of indexes in which “T” is set to the array_a in the storage unit 140. In a case of accepting an order to which the minimum number of executions S and the number of orders E are set, the setting unit 152 of the information processing apparatus 100 executes setting processing illustrated in FIG. 15.

FIG. 15 is a flowchart illustrating a processing procedure of setting processing in a case where the minimum number of executions is guaranteed. As illustrated in FIG. 15, the setting unit 152 of the information processing apparatus 100 acquires an order for which the minimum number of executions S and the number of orders E are designated (step S301).

The setting unit 152 sets the index i to an initial value 0 (step S302). In a case where “T” is set to array_a [i] (step S303, Yes), the setting unit 152 inserts a section [i+S, i+E] into a queue (step S304) and proceeds to step S306.

Here, in a case where the section at the end of the queue and the inserted section in step S304 are consecutive, the setting unit 152 merges the sections. For example, when the section at the end of the queue is [4, 6] and the inserted section is [4, 9], the setting unit 152 merges the section to [4, 9].

On the other hand, in a case where “T” is not set to array_a [i](step S303, No), the setting unit 152 proceeds to step S305. In a case where i is included in a section stored in the head of the queue, the setting unit 152 sets “T” to array_a [i] (step S305) and proceeds to step S306.

In a case where i indicates an end of the section stored in the head of the queue, the setting unit 152 deletes the section from the queue (step S306). The setting unit 152 updates the index i according to a value obtained by adding one to the index i (step S307).

In a case where i is not equal to or more than a threshold (step S308, No), the setting unit 152 proceeds to step S303. On the other hand, in a case where i is equal to or more than the threshold (step S308, Yes), the setting unit 152 proceeds to step S309.

In a case where the processing is continued (step S309, Yes), the setting unit 152 proceeds to step S301. On the other hand, in a case where the processing is not continued (step S309, No), the setting unit 152 ends the processing.

Note that, in a case where a sell order to which the minimum number of executions S and the number of orders E are set is accepted, the setting unit 152 executes the processing described with reference to FIG. 15 on the first array_a (first array information 143). In a case where a buy order to which the minimum number of executions S and the number of orders E are set is accepted, the setting unit 152 executes the processing described with reference to FIG. 15 on the second array_a (second array information 144).

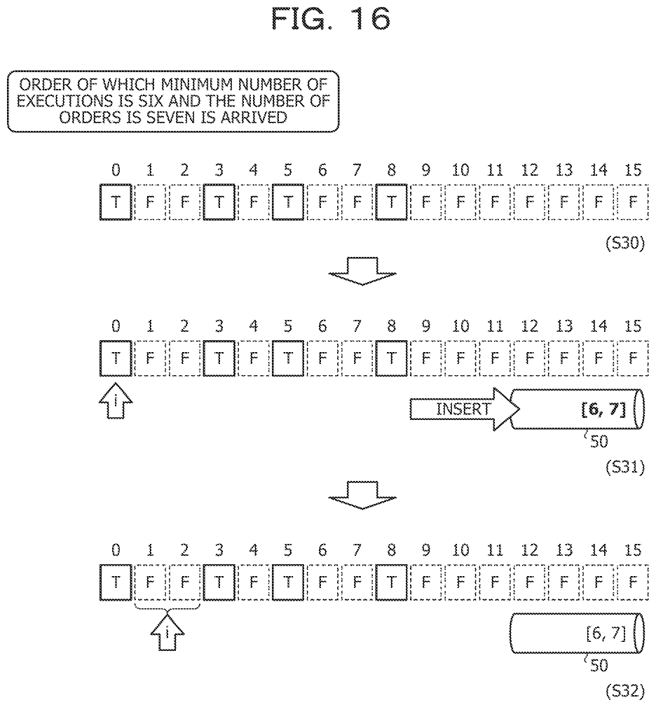

Next, an example of setting processing in a case where the minimum number of executions is guaranteed will be described. FIGS. 16 to 19 are diagrams for explaining the setting processing in a case where the minimum number of executions is guaranteed. In FIGS. 16 to 19, illustration regarding the auxiliary information is omitted. Here, as an example, a case will be described where the setting unit 152 accepts a sell order to which the minimum number of executions S=6 and the number of orders E=7 and updates the first array_a. Here, it is assumed that the state of the first array_a when the sell order is accepted is, as indicated in step S30 in FIG. 16, first array_a [0]=T, first array_a [3]=T, first array_a [5]=T, and first array_a [8]=T, and other elements are set to “F”.

Step S31 will be described. The setting unit 152 sets index i=0. Because first array_a [i]=T is set, the setting unit 152 inserts a section [6, 7](=[0+6, 0+7]) to a queue 50.

Step S32 will be described. The setting unit 152 sets index i=1. Because first array_a [i]=F is set and i is not included in the head section [6, 7] of the queue 50, no particular processing is executed. The setting unit 152 sets index i=2. Because first array_a [i]=F is set and i is not included in the head section [6, 7] of the queue 50, no particular processing is executed.

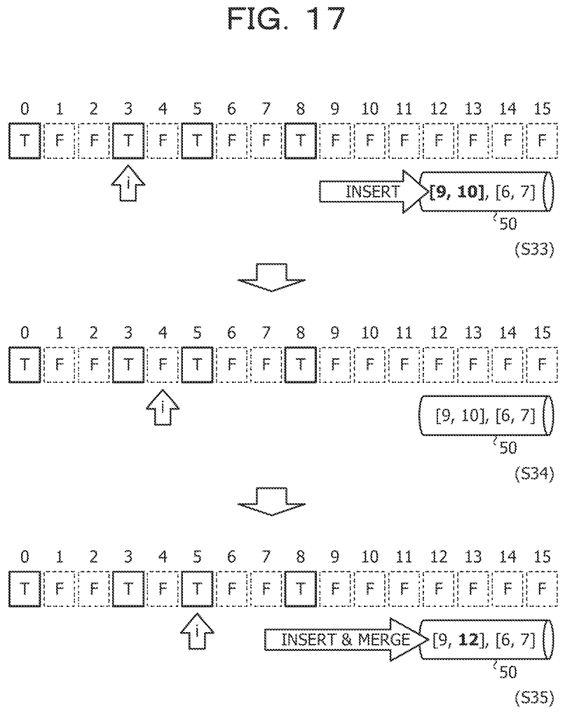

Description of FIG. 17 will be made. Step S33 will be described. The setting unit 152 sets index i=3. Because first array_a [i]=T is set, the setting unit 152 inserts a section [9, 10] (=[3+6, 3+7]) to the queue 50.

Step S34 will be described. The setting unit 152 sets index i=4. Because first array_a [i]=F is set and i is not included in the head section [6, 7] of the queue 50, no particular processing is executed.

Step S35 will be described. The setting unit 152 sets index i=5. Because first array_a [i]=T is set, the setting unit 152 inserts a section [11, 12](=[5+6, 5+7]) to the queue 50. The setting unit 152 sets a section [9, 12], which is a merged section of the section [9, 10] and the section [11, 12], to the end of the queue 50.

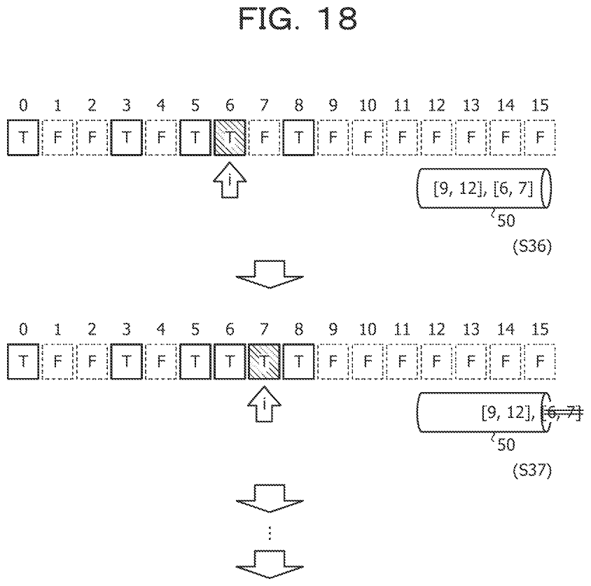

Description of FIG. 18 will be made. Step S36 will be described. The setting unit 152 sets index i=6. Because first array_a [i]=F is set and i is included in the head section [6, 7] of the queue 50, first array_a [i]=T is set.

Step S37 will be described. The setting unit 152 sets index i=7. Because first array_a [i]=F is set and i is included in the head section [6, 7] of the queue 50, first array_a [i]=T is set. Because i is the end of the head section [6, 7], the setting unit 152 deletes the section [6, 7] from the queue 50.

The setting unit 152 repeatedly executes the above processing for index i=8 to 14. Description of processing of the setting unit 152 when index i=8 to 14 is set will be omitted.

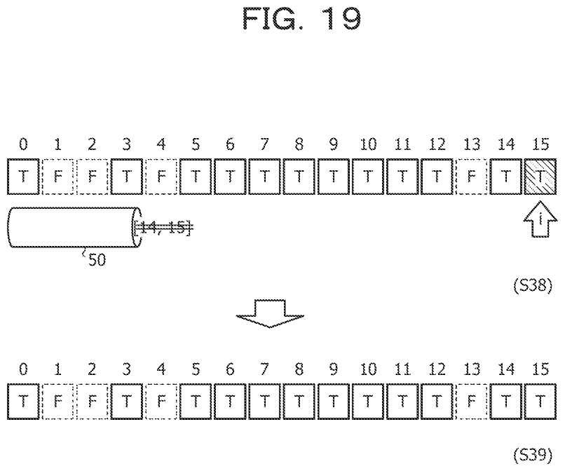

Description of FIG. 19 will be made. Step S38 will be described. The setting unit 152 sets index i=15. Because first array_a [i]=F is set and i is included in the head section [14, 15] of the queue 50, first array_a [i]=T is set. Because i is the end of the head section [14, 15], the setting unit 152 deletes the section [14, 15] from the queue 50.

Step S39 will be described. Because the first array_a exceeds the largest index i=8 to which T is set in step S30 and the queue 50 is empty, the setting unit 152 ends the processing.

In the description of FIGS. 16 to 19 described above, a case has been described where the setting unit 152 accepts a sell order to which the minimum number of executions and the number of orders are set and updates the first array_a. In a case where the setting unit 152 accepts a buy order to which the minimum number of executions and the number of orders are set and updates the second array_a, the setting unit 152 performs the update as in the processing in FIGS. 16 to 19.

The execution number calculation unit 153 of the information processing apparatus 100 calculates the maximum number of executions on the basis of the first array_a (first array information 143) and the second array_a (second array information 144) updated by the setting unit 152. In other words, for example, the execution number calculation unit 153 compares the first array information 143 and the second array information 144 and calculates the largest index among the indexes of which both of the element of the first array information 143 and the element of the second array information 144 are set to “T” as the maximum number of executions. Such a maximum number of executions is the number of executions that guarantees the minimum number of executions.

### Second Embodiment

Before explaining an information processing apparatus according to a second embodiment, a market in which a full-volume execution order that designates an amount of money is placed in the securities market will be considered. Conditions in a case of an execution are the following Conditions (1), (2), and (3).
All sell orders are executed with an amount equal to or more than an offered amount, and a partial execution is not allowed . . . . Condition (1)
All buy orders are executed with an amount equal to or less than the offered amount, and a partial execution is not allowed . . . . Condition (2)
Stock exchange does not incur a loss: (from perspective of stock exchange) A total amount obtained by sell orders should be equal to or more than a total amount to be paid for buy orders . . . . Condition (3)

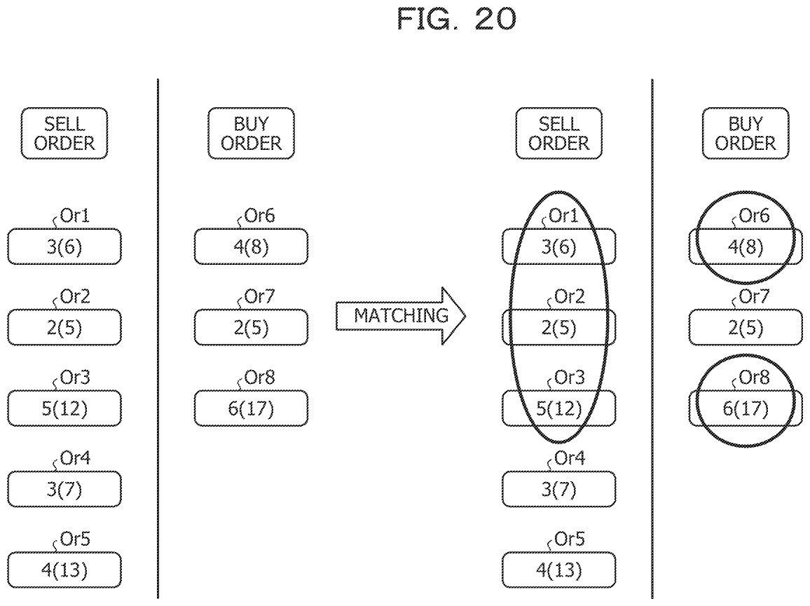

FIG. 20 is a diagram illustrating a matching example between sell orders and buy orders regarding a full-volume execution order for designating an amount. In the example illustrated in FIG. 20, orders Or1, Or2, Or3, Or4, and Or5 exist as sell orders. The order Or1 is an order of which the number of orders is “3” and a delivery amount is “60,000 yen”. The order Or2 is an order of which the number of orders is “2” and a delivery amount is “50,000 yen”. The order Or3 is an order of which the number of orders is “5” and a delivery amount is “120,000 yen”. The order Or4 is an order of which the number of orders is “3” and a delivery amount is “70,000 yen”. The order Or5 is an order of which the number of orders is “4” and a delivery amount is “130,000 yen”.

Orders Or6, Or7, and Or8 exist as buy orders. The order Or6 is an order of which the number of orders is “4” and a delivery amount is “80,000 yen”. The order Or7 is an order of which the number of orders is “2” and a delivery amount is “50,000 yen”. The order Or8 is an order of which the number of orders is “6” and a delivery amount is “170,000 yen”. The delivery amount of each of the sell orders and the buy orders indicates a delivery amount for the number of orders.

Under Conditions (1) to (3), in a case where the number of executions for the sell orders and the buy orders illustrated in FIG. 20 is maximized, the matching result is as follows. For example, the execution targets are the sell orders Or1, Or2, and Or3 and the buy orders Or6 and Or8. The total number of orders of the sell orders Or1, Or2, and Or3 is “10” and the total delivery amount is “23, and the total number of orders of the buy orders Or6 and Or8 is “10” and the total delivery amount is “25”. Therefore, Conditions (1) to (3) are satisfied.

However, in a case where the matching described with reference to FIG. 20 is performed, a knapsack problem is caused. Therefore, it is difficult to solve the problem unless some conditions are applied.

Subsequently, the information processing apparatus according to the second embodiment will be described. The information processing apparatus according to the second embodiment prepares an amount array so as to manage each of sell orders and buy orders. An amount array of sell orders is set as an array_a, and an amount array of buy orders is set as an array_b. The array_a corresponds to a first array, and the array_b corresponds to a second array.

An index i that is equal to or more than zero is set to the array_a and the array_b. The index i corresponds to the number of executions (the number of orders). The minimum value of the delivery amount of the execution is set to an element corresponding to the index i of the array_a. The information processing apparatus sets, as initial values of the array_a, array_a [0]=0 and array_a [i]=∞ (sufficiently large value) for index i>0. The maximum value of the delivery amount of the execution is set to an element corresponding to the index i of the array_b. The information processing apparatus sets, an initial value of the array_b, array_b [0]=0 and array_b [i]=−∞ (sufficiently small value) for index i>0.

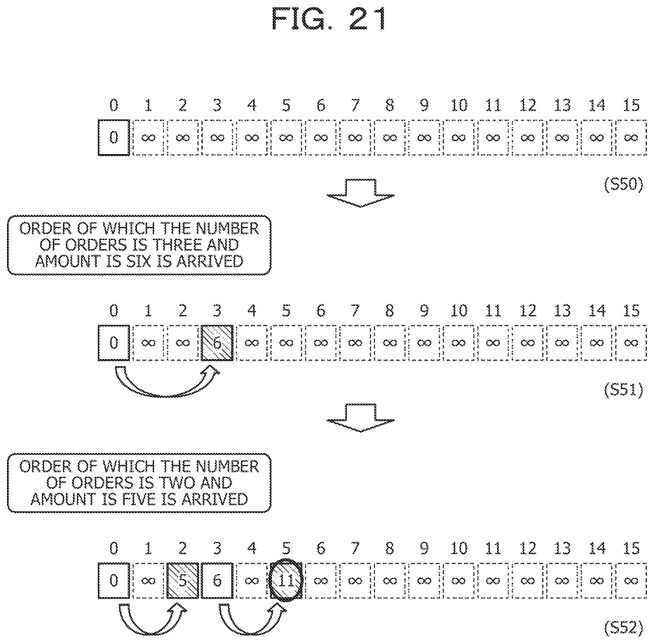

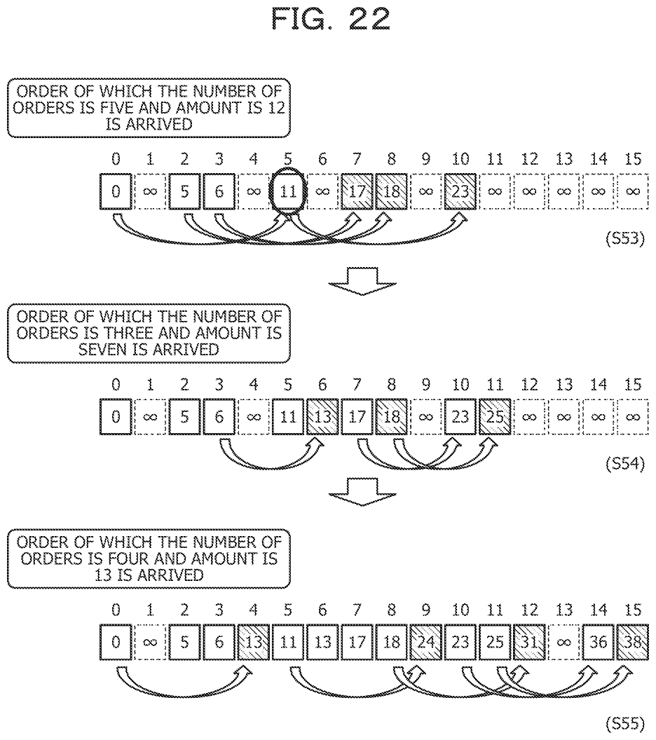

First, processing for calculating the maximum number of executions that may be matched by the information processing apparatus according to the second embodiment will be described. FIGS. 21 and 22 are diagrams for explaining processing on the array_a in a case where a sell order is accepted. In a case where array_a [i]<∞ and an order with the number of orders x and an amount p is arrived, if array_a [i+x]>array_a [i]+p, the information processing apparatus sets array_a [i+x]=array_a [i]+p (update if value of element decreases).

FIG. 21 will be described. It is assumed that an initial state of the array_a be as indicated in step S50. In the initial state of the array_a, array_a [0]=0, and all other elements are set to “∞”.

In a case where a sell order of which the number of orders is three and an amount is six (ten thousand yen, omitted below) is accepted, the state of the array_a is as indicated in step S51. Because array_a [0+3]=∞ and array_a [0]+p=6, array_a [0+3]>array_a [0]+p. Therefore, the information processing apparatus sets array_a [0+3]=6.

In a case where a sell order of which the number of orders is two and an amount is five is accepted, the state of the array_a is as indicated in step S52. Because array_a [0+2]=∞ and array_a [0]+p=5, array_a [0+2]>array_a [0]+p. Therefore, the information processing apparatus sets array_a [0+2]=5. Because array_a [3+2]=∞ and array_a [3]+p=11, array_a [3+2]>array_a [3]+p. Therefore, the information processing apparatus sets array_a [3+2]=11.

Description of FIG. 22 will be made. In a case where a sell order of which the number of orders is five and an amount is 12 is accepted, the state of the array_a is as indicated in step S53. Because array_a [0+5]=11 and array_a [0]+p=12, array_a [0+5]<array_a [0]+p. Therefore, the information processing apparatus maintains array_a [0+5]=11 (does not update).

Because array_a [2+5]=∞ and array_a [2]+p=17, array_a [2+5]>array_a [2]+p. Therefore, the information processing apparatus sets array_a [2+5]=17. Because array_a [3+5]=∞ and array_a [3]+p=18, array_a [3+5]>array_a [3]+p. Therefore, the information processing apparatus sets array_a [3+5]=18.

Because array_a [5+5]=∞ and array_a [5]+p=13, array_a [5+5]>array_a [5]+p. Therefore, the information processing apparatus sets array_a [5+5]=23.

In a case where a sell order of which the number of orders is three and an amount is seven is accepted, the state of the array_a is as indicated in step S54. Because array_a [0+3]=6 and array_a [0]+p=7, array_a [0+3]<array_a [0]+p. Therefore, the information processing apparatus maintains array_a [0+3]=6 (does not update). Because array_a [2+3]=11 and array_a [2]+p=12, array_a [2+3]<array_a [2]+p. Therefore, the information processing apparatus maintains array_a [2+3]=11 (does not update).

Because array_a [3+3]=∞ and array_a [3]+p=13, array_-a [3+3]>array_a [3]+p. Therefore, the information processing apparatus sets array_a [3+3]=13. Because array_a [3+5]=18 and array_a [5]+p=18, array_a [3+5]=array_a [5]+p. Therefore, the information processing apparatus maintains array_a [3+5]=18.

Because array_a [7+3]=23 and array_a [7]+p=24, array_a [7+3]<array_a [7]+p. Therefore, the information processing apparatus maintains array_a [7+3]=13 (does not update). Because array_a [8+3]=∞ and array_a [8]+p=25, array_a [8+3]>array_a [8]+p. Therefore, the information processing apparatus sets array_a [8+3]=25.

In a case where a sell order of which the number of orders is four and an amount is 13 is accepted, the state of the array_a is as indicated in step S55. Because array_a [0+4]=∞ and array_a [0]+p=13, array_a [0+4]>array_a [0]+p. Therefore, the information processing apparatus sets array_a [0+4]=13. Because array_a [2+4]=13 and array_a [2]+p=18, array_a [2+4]<array_a [2]+p. Therefore, the information processing apparatus maintains array_a [2+4]=13 (does not update).

Because array_a [3+4]=17 and array_a [3]+p=19, array_a [3+4]<array_a [3]+p. Therefore, the information processing apparatus maintains array_a [3+4]=17 (does not update). Because array_a [5+4]=co and array_a [5]+p=24, array_a [5+6]>array_a [5]+p. Therefore, the information processing apparatus sets array_a [5+4]=24.

Because array_a [6+4]=23 and array_a [6]+p=24, array_a [6+4]<array_a [6]+p. Therefore, the information processing apparatus maintains array_a [6+4]=23 (does not update). Because array_a [7+4]=25 and array_a [7]+p=28, array_a [7+4]<array_a [7]+p. Therefore, the information processing apparatus maintains array_a [7+4]=25 (does not update).

Because array_a [8+4]=∞ and array_a [8]+p=31, array_a [8+4]>array_a [8]+p. Therefore, the information processing apparatus sets array_a [8+4]=31. Because array_a [10+4]=∞ and array_a [10]+p=36, array_a [10+4]>array_a [10]+p. Therefore, the information processing apparatus sets array_a [10+4]=36. Because array_a [11+4]=∞ and array_a [11]+p=38, array_a [11+4]>array_a [11]+p. Therefore, the information processing apparatus sets array_a [11+4]=38.

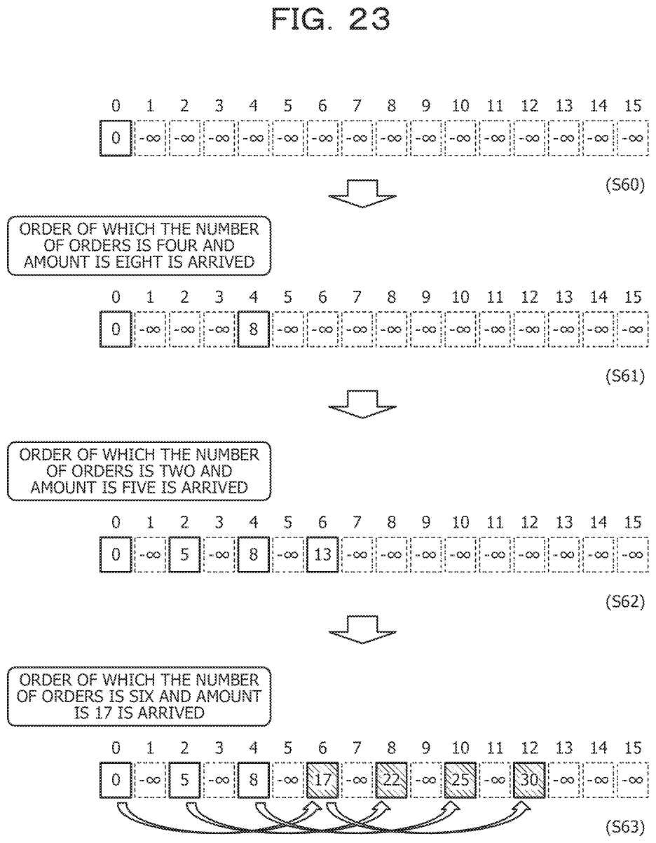

FIG. 23 is a diagram for explaining processing on the array_b in a case where a buy order is accepted. In a case where array_b [i]>−∞ and an order with the number of orders x and an amount p is arrived, if array_b [i+x]<array_b [i]+p, the information processing apparatus sets array_b [i+x]=array_b [i]+p (update if value of element increases).

It is assumed that an initial state of the array_b be as indicated in step S60. In the initial state of the array_b, array_b [0]=0, and all other elements are set to “−∞”.

In a case where a buy order of which the number of orders is four and an amount is eight (ten thousand yen, omitted below) is accepted, the state of the array_b is as indicated in step S61. Because array_b [0+4]=−∞ and array_b [0]+p=8, array_b [0+4]<array_b [0]+p. Therefore, the information processing apparatus sets array_b [0+4]=8.

In a case where a buy order of which the number of orders is two and an amount is five is accepted, the state of the array_b is as indicated in step S62. Because array_b [0+2]=−∞ and array_b [0]+p=5, array_b [0+2]<array_b [0]+p. Therefore, the information processing apparatus sets array_b [0+2]=5. Because array_b [4+2]=−∞ and array_b [4]+p=13, array_b [4+2]<array_b [4]+p. Therefore, the information processing apparatus sets array_b [4+2]=13.

In a case where a buy order of which the number of orders is six and an amount is 17 is accepted, the state of the array_b is as indicated in step S63. Because array_b [0+6]=−∞ and array_b [0]+p=17, array_b [0+6]<array_b [0]+p. Therefore, the information processing apparatus sets array_b [0+6]=17.

Because array_b [2+6]=−∞ and array_b [2]+p=22, array_b [2+6]<array_b [2]+p. Therefore, the information processing apparatus sets array_b [2+6]=22. Because array_b [4+6]=−∞ and array_b [4]+p=25, array_b [4+6]<array_b [4]+p. Therefore, the information processing apparatus sets array_b [4+6]=25.

Because array_b [6+6]=−∞ and array_b [6]+p=30, array_b [6+6]<array_b [6]+p. Therefore, the information processing apparatus sets array_b [6+6]=30.

The information processing apparatus according to the second embodiment compares the array_a described with reference to FIGS. 21 and 22 and the array_b described with reference to FIG. 23 and specifies the maximum number of executions that may be matched.

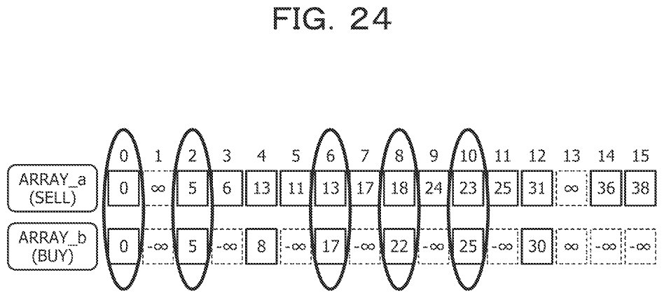

FIG. 24 is a diagram for explaining an example of processing for calculating the number of executions according to the second embodiment. The information processing apparatus scans the array_a of sell orders and the array_b of buy orders for each index and calculates the maximum index i that satisfies array_a [i] s array_b [i] as the maximum number of executions. In the example illustrated in FIG. 24, the largest index among the indexes that satisfy array_a [i]≤array_b [i] is index i=10, the information processing apparatus calculates the maximum number of executions as “10”.

The information processing apparatus according to the second embodiment, similarly to the information processing apparatus 100 according to the first embodiment, may specify orders to be executed by registering auxiliary information indicating an order acceptance sequence (order sequence) and a volume (the number of orders) for each index.

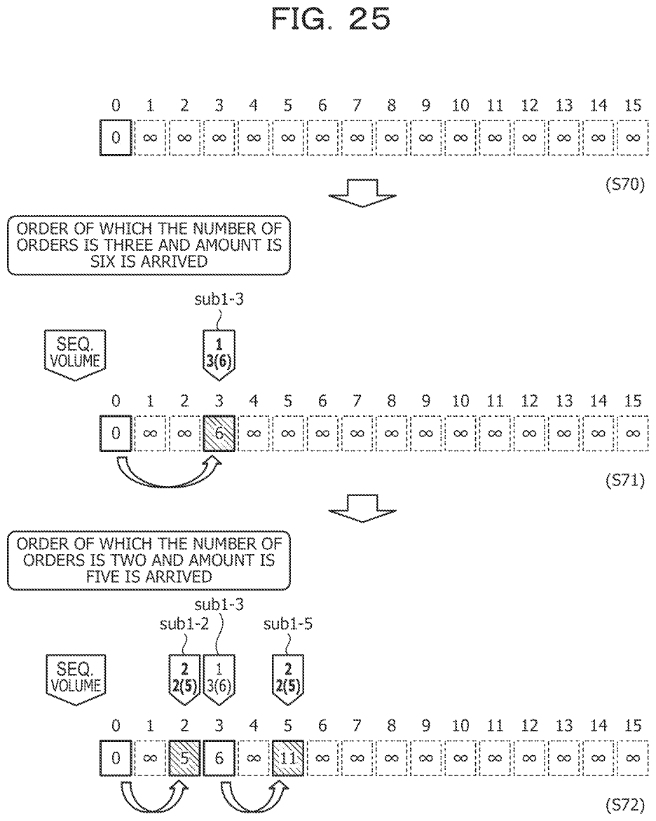

FIG. 25 is a diagram for explaining the processing on the array_a in a case where a sell order is accepted. It is assumed that an initial state of the array_a be as indicated in step S70. In the initial state of the array_a, array_a [0]=0, and all other elements are set to “∞”.

In a case where a sell order of which the number of orders is three and an amount is six is accepted first (order acceptance sequence=1), the state of the array_a is as indicated in step S71. As in step S51 in FIG. 21, the information processing apparatus sets array_a [0+3]=6. Furthermore, the information processing apparatus registers auxiliary information sub1-3 for index i=3. A sequence “1”, a volume “3 (amount 6)” are set to the auxiliary information sub1-3.

Subsequently (order acceptance sequence=2), in a case where a sell order of which the number of orders is two and an amount is five is accepted, the state of the array_a is as indicated in step S72. As in step S52 in FIG. 21, the information processing apparatus sets array_a [0+2]=5. The information processing apparatus registers auxiliary information sub1-2 for index i=2. A sequence “2” and a volume “2 (amount 5)” are set to the auxiliary information sub1-2.

As in step S52 in FIG. 21, the information processing apparatus sets array_a [3+2]=11. The information processing apparatus registers auxiliary information sub1-5 for index i=5. A sequence “2” and a volume “2 (amount 5)” are set to the auxiliary information sub1-5.

The information processing apparatus repeatedly executes the above processing each time when a sell order is accepted.

Although not illustrated, in a case of accepting a buy order, the information processing apparatus sets an amount of money to the element of the array_b and registers auxiliary information for an index as in FIG. 25. Processing for setting an amount of money to the element of the array_b by the information processing apparatus is similar to that in FIG. 23.

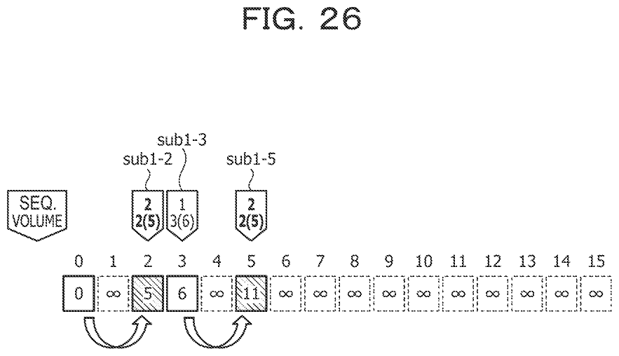

FIG. 26 is a diagram for explaining processing for specifying execution target orders according to the second embodiment. The processing for specifying execution target orders according to the second embodiment is basically similar to the processing described with reference to FIGS. 5 and 6.

After calculating the number of executions, the information processing apparatus specifies orders to be executed on the basis of the auxiliary information set to the array_a. In a case where an execution is made with the number of executions i₀, the information processing apparatus sets an initial value of the index as i=i₀ and repeatedly executes the following processing until i=0 is satisfied.

The processing repeated by the information processing apparatus is the following processing. The information processing apparatus sets an order of array_a [i] corresponding to the index i as an execution target. Next, the information processing apparatus specifies a volume a included in auxiliary information set to array_a [i] and updates the index i according to i=i−a.

On the basis of the array_a in FIG. 26, processing for specifying sell orders to be executed by the information processing apparatus will be described. Furthermore, it is assumed that i₀=5. The information processing apparatus sets an order corresponding to the auxiliary information sub1-5 set for index i=5 corresponding to the number of executions “5” as an execution target. The information processing apparatus acquires a volume a=2 included in the auxiliary information sub1-5 and updates the index i to index i=5−2=3.

The information processing apparatus sets an order corresponding to the auxiliary information sub1-3 set for index i=3 as an execution target. The information processing apparatus acquires a volume a=3 included in the auxiliary information sub1-3 and updates the index i to index i=3−3=0. Because index i=0, the information processing apparatus ends the processing.

According to the above processing, the information processing apparatus specifies “the sell order of which the number of orders is three and the amount is six” and “the sell order of which the number of orders is two and the amount is five” described with reference to FIG. 25 as execution targets. Although not illustrated, the information processing apparatus also executes the processing corresponding to FIG. 26 on the array_b and specifies buy orders to be executed.

As described above, the information processing apparatus according to the second embodiment sets information based on an order sequence, the number of orders, and an amount of money regarding a sell order to the array_a in a case where the sell order is accepted and sets information based on an order sequence, the number of orders, and an amount of money regarding a buy order to the array_b in a case where the buy order is accepted. The information processing apparatus calculates the maximum number of executions on the basis of the information set to the array_a and the information set to the array_b. Then, the information processing apparatus specifies orders to be executed on the basis of the calculated maximum number of executions, the information set to the array_a, and the information set to the array_b. In other words, for example, according to the information processing apparatus according to the second embodiment, it is possible to specify the orders to be the execution target of which the number of executions is maximized while satisfying Conditions (1), (2), and (3).

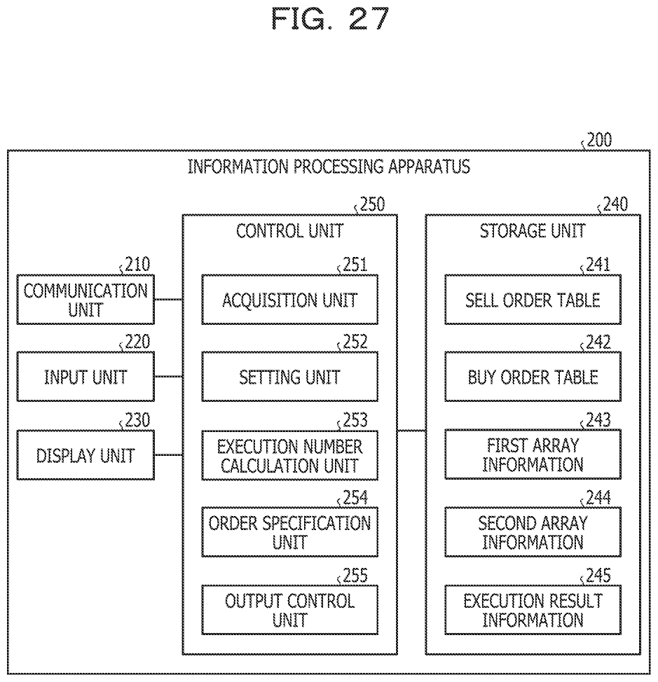

Next, an example of a configuration of the information processing apparatus that executes the processing described with reference to FIGS. 21 to 26 will be described. FIG. 27 is a diagram illustrating a configuration of an information processing apparatus according to the second embodiment. As illustrated in FIG. 27, an information processing apparatus 200 includes a communication unit 210, an input unit 220, a display unit 230, a storage unit 240, and a control unit 250.

The communication unit 210 is wired or wirelessly coupled to an external device or the like and exchanges information with the external device or the like. For example, the communication unit 210 is implemented by an NIC or the like. The communication unit 210 may be coupled to a network (not illustrated). For example, the communication unit 210 receives information regarding a sell order table 241 including information regarding sell orders, information regarding a buy order table 242 including information regarding buy orders, or the like from the external device. For example, the external device corresponds to a server that manages buying and selling of stocks and executes various types of processing on an execution target order.

The input unit 220 is an input device that inputs various types of information to the information processing apparatus 200. The input unit 220 corresponds to a keyboard, a mouse, a touch panel, or the like.

The display unit 230 is a display device that displays information output from the control unit 250. The display unit 230 corresponds to a liquid crystal display, an organic EL display, a touch panel, or the like.

The storage unit 240 includes the sell order table 241, the buy order table 242, first array information 243, second array information 244, and execution result information 245. For example, the storage unit 240 is implemented by a semiconductor memory element such as a RAM or a flash memory or a storage device such as a hard disk or an optical disk.

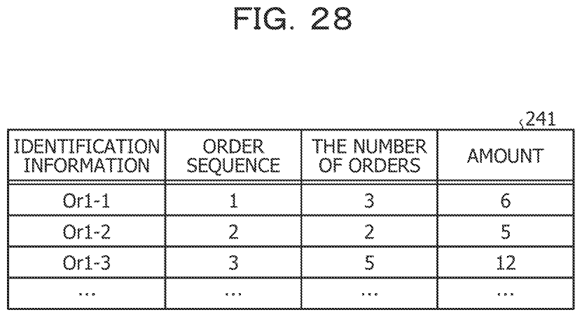

The sell order table 241 is a table that holds an order sequence, the number of orders, and an amount of money regarding a sell order. FIG. 28 is a diagram illustrating an example of a data structure of the sell order table 241 according to the second embodiment. As illustrated in FIG. 28, the sell order table 241 associates identification information, the order sequence, the number of orders, and the amount of money. The identification information is information that uniquely identifies a sell order. The order sequence is an order of an accepted sell order. The number of orders is the number of sell orders. The amount of money is a designated amount of money regarding the sell order.

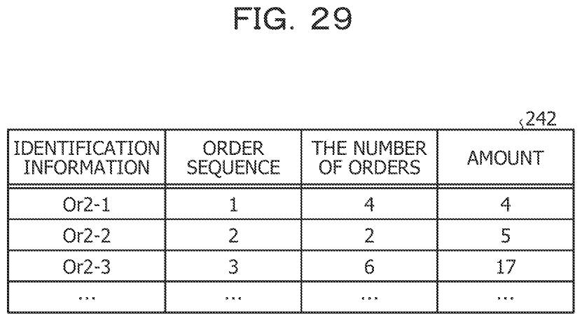

The buy order table 242 is a table that holds an order sequence, the number of orders, and an amount of money regarding a buy order. FIG. 29 is a diagram illustrating an example of a data structure of the buy order table 242 according to the second embodiment. As illustrated in FIG. 29, the buy order table 242 associates identification information, the order sequence, the number of orders, and the amount of money. The identification information is information that uniquely identifies a buy order. The order sequence is an order of an accepted buy order. The number of orders is the number of buy orders. The amount of money is a designated amount of money regarding the buy order.

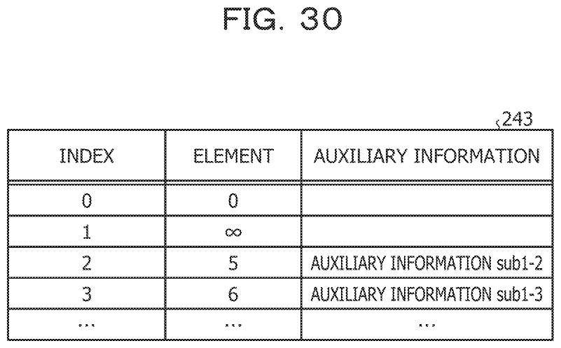

The first array information 243 is array information that holds information based on the order sequence, the number of orders, and the amount of money regarding sell orders. The first array information 243 corresponds to the array_a described above. FIG. 30 is a diagram illustrating an example of a data structure of the first array information 243. As illustrated in FIG. 30, the first array information 243 includes an index, an element, and auxiliary information. The index corresponds to the index i of the array_a. The element is an element of the array_a, and an amount of money is set to the element. The auxiliary information is information indicating an order acceptance sequence (order sequence) and a volume (the number of orders).

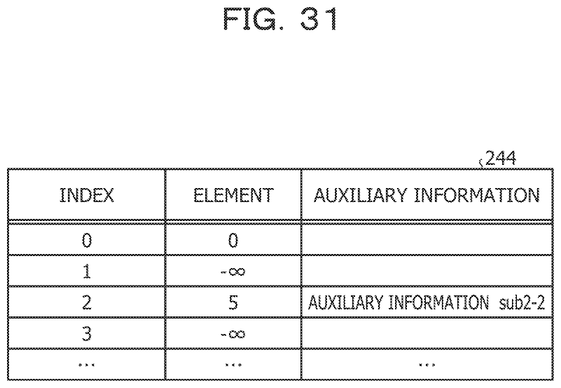

The second array information 244 is array information that holds information based on the order sequence, the number of orders, and the amount of money regarding buy orders. The second array information 244 corresponds to the array_b described above. FIG. 31 is a diagram illustrating an example of a data structure of the second array information 244 according to the second embodiment. As illustrated in FIG. 31, the second array information 244 includes an index, an element, and auxiliary information. The index corresponds to the index i of the array_b. The element is an element of the array_b, and an amount of money is set to the element. The auxiliary information is information indicating an order acceptance sequence (order sequence) and a volume (the number of orders).

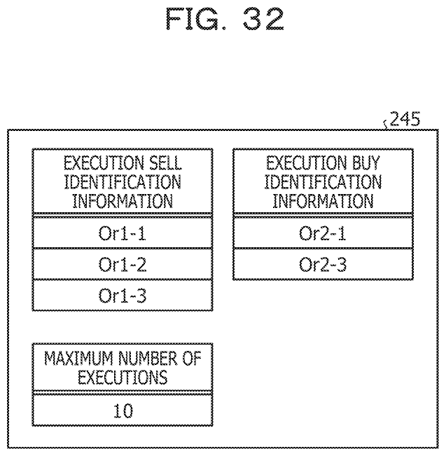

The execution result information 245 holds information regarding the maximum number of executions and orders to be executed. FIG. 32 is a diagram illustrating an example of a data structure of the execution result information 245 according to the second embodiment. As illustrated in FIG. 32, the execution result information 245 includes execution sell identification information, execution buy identification information, and the maximum number of executions. The execution sell identification information is information that identifies sell orders to be executed. The execution buy identification information is information that identifies buy orders to be executed. The maximum number of executions indicates the largest number of executions.

The description returns to FIG. 27. The control unit 250 includes an acquisition unit 251, a setting unit 252, an execution number calculation unit 253, an order specification unit 254, and an output control unit 255. The control unit 250 is, for example, implemented by a CPU or an MPU. Furthermore, for example, the control unit 250 may be executed by an integrated circuit such as an ASIC or an FPGA.

In a case of acquiring data of the sell order table 241 from an external device or the like, the acquisition unit 251 stores the data of the sell order table 241 in the storage unit 240. The acquisition unit 251 may individually acquire sell orders in sequence and register information regarding the acquired sell orders to the sell order table 241.

When the acquisition unit 251 acquires data of the buy order table 242 from an external device or the like, the acquisition unit 251 stores the data of the buy order table 242 in the storage unit 240. The acquisition unit 251 may individually acquire buy orders in sequence and register information regarding the acquired buy orders to the buy order table 242.

The setting unit 252 sets the information based on the order sequence, the number of orders, and the amount of money regarding sell orders to the first array information 243 (array_a) on the basis of the sell order table 241. Furthermore, the setting unit 252 sets the information based on the order sequence and the number of orders regarding buy orders to the second array information 244 (array_b) on the basis of the buy order table 242.

The processing for setting the information based on the order sequence, the number of orders, and the amount of money regarding the sell orders to the first array information 243 on the basis of the sell order table 241 by the setting unit 252 corresponds to the processing on the array_a described with reference to FIGS. 21, 22, 26, or the like. In a case where array_a [i]<∞ and an order with the number of orders x and an amount p is arrived, if array_a [i+x]>array_a [i]+p, the setting unit 252 sets array_a [i+x]=array_a [i]+p (update if value of element decreases). Furthermore, in a case of update, the setting unit 252 registers the auxiliary information in association with the index i.

The processing for setting the information based on the order sequence, the number of orders, and the amount of money regarding the buy orders to the second array information 244 on the basis of the buy order table 242 by the setting unit 252 corresponds to the processing on the array_b described with reference to FIG. 23 or the like. In a case where array_b [i]>−∞ and an order with the number of orders x and an amount p is arrived, if array_b [i+x]<array_b [i]+p, the setting unit 252 sets array_b [i+x]=array_b [i]+p (update if value of element increases). Furthermore, in a case of update, the setting unit 252 registers the auxiliary information in association with the index i.

The execution number calculation unit 253 is a processing unit that calculates the maximum number of executions of sell orders and buy orders on the basis of the first array information 243 and the second array information 244. The processing of the execution number calculation unit 253 corresponds to the processing described with reference to FIG. 24. The execution number calculation unit 253 scans the first array information 243 (array_a) and the second array information 244 (array_b) for each index and calculates the maximum index i that satisfies array_a [i] s array_b [i] as the maximum number of executions. The execution number calculation unit 253 registers the calculated maximum number of executions to the execution result information 245.

The execution number calculation unit 253 may execute the above processing at a timing when an instruction for determining the number of executions is accepted from the input unit 220 or the external device or the like. The execution number calculation unit 253 may execute the above processing at a timing when a predetermined time elapses after the setting unit 252 sets the first array information 243 and the second array information 244.

The order specification unit 254 is a processing unit that specifies orders to be executed on the basis of the maximum number of executions, the first array information 243, and the second array information 244. The processing of the order specification unit 254 corresponds to the processing described with reference to FIG. 26. In a case where an execution is made with the number of executions (the maximum number of executions) i₀, the order specification unit 254 sets an initial value of index i=i₀ and repeatedly executes the following processing until i=0 is satisfied.

The order specification unit 254 sets an order of array_a [i] corresponding to the index i as an execution target. Next, the order specification unit 254 specifies a volume a included in auxiliary information set to array_a [i] and updates the index i according to i=i−a. By repeatedly executing the processing until i=0 is satisfied, the order specification unit 254 specifies sell orders to be executed.

The order specification unit 254 sets an order of array_b [i] corresponding to the index i as an execution target. Next, the order specification unit 254 specifies a volume a included in auxiliary information set to array_b [i] and updates the index i according to i=i−a. By repeatedly executing the processing until i=0 is satisfied, the order specification unit 254 specifies buy orders to be executed.

The order specification unit 254 registers the identification information of the execution target orders specified by executing the above processing to the execution result information 245.

The output control unit 255 is a processing unit that outputs the execution result information 245 to the display unit 230 and makes the display unit 230 display the execution result information 245. The output control unit 255 may transmit the execution result information 245 to an external device and request various types of execution processing.

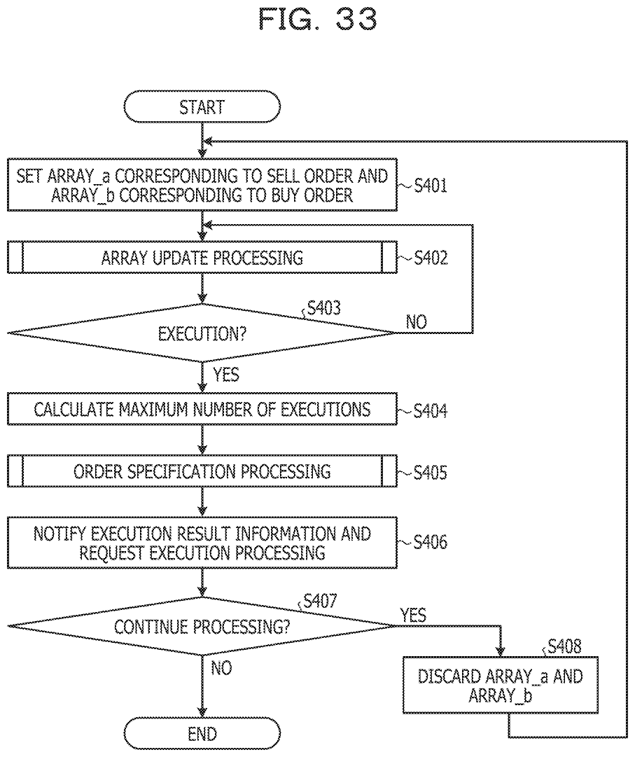

Next, an example of a processing procedure of the information processing apparatus 200 according to the second embodiment will be described. FIG. 33 is a flowchart illustrating a processing procedure of an information processing apparatus according to the second embodiment. As illustrated in FIG. 33, the setting unit 252 of the information processing apparatus 200 sets an array_a regarding sell orders and an array_b regarding buy orders (step S401). The information regarding the array_a corresponds to the first array information 243. The information regarding the array_b corresponds to the second array information 244.

The setting unit 252 executes array update processing (step S402). In a case where no orders are executed (step S403, No), the information processing apparatus 200 proceeds to step S402. In a case where orders are executed (step S403, Yes), the information processing apparatus 200 proceeds to step S404.

The execution number calculation unit 253 of the information processing apparatus 200 calculates the maximum number of executions (step S404). The order specification unit 254 of the information processing apparatus 200 executes order specification processing (step S405).

The output control unit 255 of the information processing apparatus 200 notifies an external device or the like of execution result information and requests execution processing (step S406). In a case where the processing is continued (step S407, Yes), the information processing apparatus 200 proceeds to step S408. The setting unit 252 discards the array_a and the array_b (step S408) and proceeds to step S401.

On the other hand, in a case where the processing is not continued (step S407, No), the information processing apparatus 200 ends the processing.

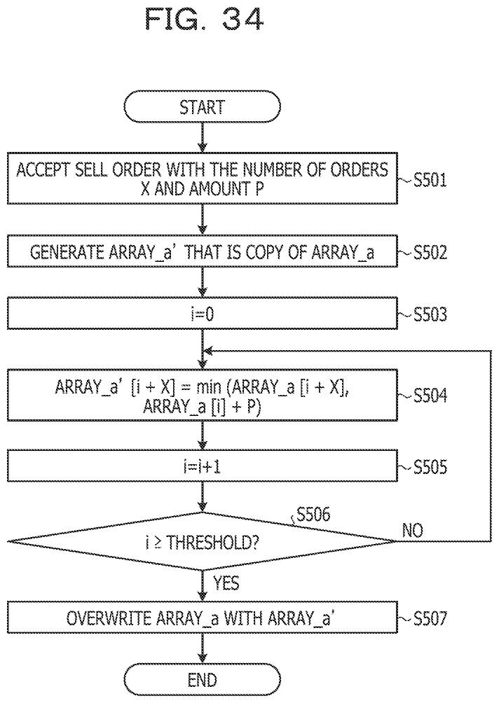

Next, a processing procedure of the array update processing described in step S402 in FIG. 33 will be described. FIG. 34 is a flowchart illustrating a processing procedure of array update processing of a sell order according to the second embodiment. The setting unit 252 of the information processing apparatus 200 accepts a sell order with the number of orders X and an amount P (step S501).

The setting unit 252 generates an array_a′ that is a copy of the array_a (step S502). The setting unit 252 sets i to zero that is an initial value (step S503). The setting unit 252 updates the array_a′ according to the array_a′ [i+X]=min (array_a [i+X], array_a [i]+P) (step S504).

The setting unit 252 updates i according to a value obtained by adding one to i (step S505). In a case where i is not equal to or more than a threshold (step S506, No), the setting unit 252 proceeds to step S504. On the other hand, in a case where i is equal to or more than the threshold (step S506, Yes), the setting unit 252 overwrites the array_a with the array_a′ (step S507).

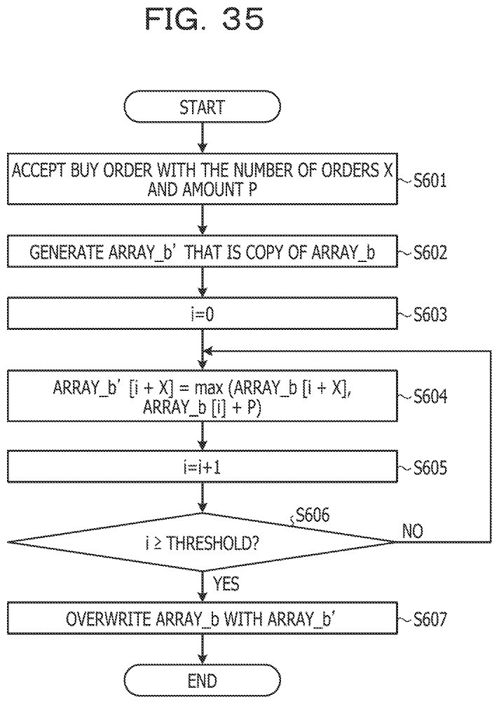

FIG. 35 is a flowchart illustrating a processing procedure of array update processing of a buy order according to the second embodiment. The setting unit 252 of the information processing apparatus 200 accepts a buy order with the number of orders X and an amount P (step S601).

The setting unit 252 generates an array_b′ that is a copy of the array_b (step S602). The setting unit 252 sets i to zero that is an initial value (step S603). The setting unit 252 updates the array_b′ according to the array_b′ [i+X]=max (array_b [i+X], array_b [i]+P) (step S604).

The setting unit 252 updates i according to a value obtained by adding one to i (step S605). In a case where i is not equal to or more than a threshold (step S606, No), the setting unit 252 proceeds to step S604. In a case where i is equal to or more than the threshold (step S606, Yes), the setting unit 252 overwrites the array_b with the array_b′ (step S607).

Note that the processing procedure of the order specification processing described in step S405 in FIG. 33 corresponds to the processing procedure described in FIG. 14 according to the first embodiment.

Next, effects of the information processing apparatus 200 according to the second embodiment will be described. The information processing apparatus 200 sets information based on an order sequence, the number of orders, and an amount of money regarding a sell order to the array_a in a case where the sell order is accepted and sets information based on an order sequence, the number of orders, and an amount of money regarding a buy order to the array_b in a case where the buy order is accepted. The information processing apparatus 200 calculates the maximum number of executions on the basis of the information set to the array_a and the information set to the array_b. Then, the information processing apparatus specifies orders to be executed on the basis of the calculated maximum number of executions, the information set to the array_a, and the information set to the array_b. In other words, for example, according to the information processing apparatus according to the second embodiment, it is possible to specify orders to be the execution target of which the number of executions is maximized while satisfying Conditions (1), (2), and (3).

Furthermore, the information processing apparatus 200 scans the first array information 243 (array_a) and the second array information 244 (array_b) for each index and calculates the maximum index i that satisfies array_a [i]≤array_b [i] as the maximum number of executions. As a result, by comparing the array_a and the array_b, it is possible to easily specify the maximum number of executions. Furthermore, the auxiliary information is used to trace the indexes of the array_a and the array_b, and it is possible to specify orders to be executed.

### Third Embodiment

By the way, the information processing apparatus 200 described above may accept an order including an order condition in which prices at multiple stages are set depending on the number of orders. Specifically, for example, the information processing apparatus 200 accepts an order including an order condition in which amounts of money differ according to the number of orders such that an amount is equal to or more than 19,000 yen for one share, equal to or more than 36,000 yen for two shares, and equal to or more than 51,000 yen for three shares. Here, regarding the order in which prices at multiple stages are set depending on the number of orders, it is assumed that, although a full-volume execution or full cancellation at one stage be allowed, an execution at a plurality of stages (for example, executing one share and three shares and delivering 1.9+5.1=70,000 yen) be not allowed.

In a case where an order including the order condition in which the prices at multiple stages are set depending on the number of orders is accepted, the information processing apparatus 200 executes the following processing and individually updates an array for each stage (however, the update is performed on an array before each stage is reflected).

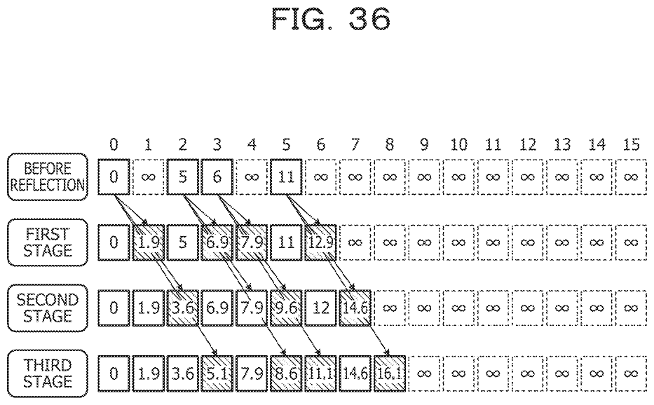

FIG. 36 is a diagram for explaining processing according to a third embodiment. In FIG. 36, an array_a will be described. Furthermore, it is assumed that the information processing apparatus 200 accepts an order including an order condition in which prices at three stages are set depending on the number of orders, such that a price is equal to or more than 19,000 yen for one share, equal to or more than 36,000 yen for two shares, and equal to or more than 51,000 yen for three shares.

As illustrated in FIG. 36, the information processing apparatus 200 individually updates the array_a for each order stage. Before reflection, the array_a is set as array_a [0]=0, array_a [2]=5, array_a [3]=6, and array_a [5]=11, and other elements are set to co.

The array_a at a first stage will be described. At the first stage, in a case where array_a [i+1]>array_a [i]+1.9, processing for updating to array_a [i+1]=array_a [i]+1.9 is repeatedly executed while incrementing the index i. As a result, elements of array_a [0] to array_a [6] are respectively set as 0, 1.9, 5, 6.9, 7.9, 11, and 12.9.

The array_a at a second stage will be described. At the second stage, regarding the array_a at the first stage, in a case where array_a [i+2]>array_a [i]+3.6, processing for updating to array_a [i+2]=array_a [i]+3.6 is repeatedly executed while incrementing the index i. As a result, elements of array_a [0] to array_a [7] are respectively set as 0, 1.9, 3.6, 6.9, 7.9, 9.6, 12, and 14.6.

The array_a at a third stage will be described. At the third stage, regarding the array_a at the second stage, in a case where array_a [i+3]>array_a [i]+5.1, processing for updating to array_a [i+3]=array_a [i]+5.1 is repeatedly executed while incrementing the index i. As a result, elements of array_a [0] to array_a [8] are respectively set as 0, 1.9, 3.6, 5.1, 7.9, 8.6, 11.1, 14.6, and 16.1.

In the example illustrated in FIG. 36, a case has been described where the array_a is individually updated for each order stage. However, the array_b may be similarly updated. Furthermore, the information processing apparatus described in the second and third embodiments may update the array_a and the array_b using a segment tree in a case of updating the array_a and the array_b.

Here, in a case of a transaction in which the number of executions is guaranteed by finely designating a price for each number of orders (the number of executions) as multiple stages, when the number of orders is set to n, reflection to the existing array described above needs a calculation amount of O (n²), and a calculation cost increases.

Therefore, in a case where an array corresponding to the order condition in which prices at multiple stages are set depending on the number of orders is reflected on the existing array to which orders are set, the setting units 152 and 252 of the information processing apparatuses 100 and 200 according to the third embodiment perform convolution using the Try-And-Clean-Up (TACU) algorithm.

The TACU algorithm is an algorithm proposed in “Fast algorithms for the maximum convolution problem” authored by Michael Bussieck, Hannes Hassler, Gerhard J. Woeginger, and Uwe T. Zimmermann. With this TACU algorithm, maximum value convolution may be performed with a calculation amount of O (nlogn), and it is possible to reduce a calculation cost.

Specifically, for example, in the TACU algorithm, two sequences to be input for convolution are a and b. Here, the sequences a and b are respectively set as a sequence with n terms a₀, a₁, . . . , aₙ₋₁ and a sequence with n terms b₀, b₁, . . . , bₙ₋₁. Furthermore, it is assumed that an output of the TACU algorithm, that is, for example, the convolution result be cₖ=max (0≤i≤n−1) {aₖ₋ₗ−bᵢ}.

In the TACU algorithm, the convolution result cₖ is calculated by an algorithm including the following (1) to (4).
(1) Initialize with cₖ=−∞.
(2) Extract n·ln n values from a larger set {aᵢ+bⱼ|0≤i, j≤n−1}, and set as w₁, w₂, . . . , w_{n·ln n}.
(3) When wₗ=aᵢ+aⱼ>cᵢ₊ⱼ is satisfied for all subscripts l=1, . . . , n·ln n, set cᵢ₊ⱼ=wₗ.
(4) Calculate cₖ=max {aₖ₋ₗ+bᵢ} for cₖ which remains as cₖ=−∞.

What this algorithm does is as follows. Of subscripts k, those included in n·ln n from the largest (called good subscripts) are adopted. Of subscripts k, those not included in n·ln n from the largest (called bad subscripts) are directly calculated. It may be proved that the direct calculation of the bad subscripts is averagely reduced, and an average calculation amount of O (nlogn) is needed as a whole. In a case convolving to the minimum value, the algorithm may be applied by changing “large” in the algorithm described above to “small”, changing −∞ to +∞, and reversing the direction of the inequality sign.

By the convolution using this TACU algorithm, the information processing apparatuses 100 and 200 execute processing as follows in a case of reflecting the array corresponding to the order condition in which prices at multiple stages are set depending on the number of orders.

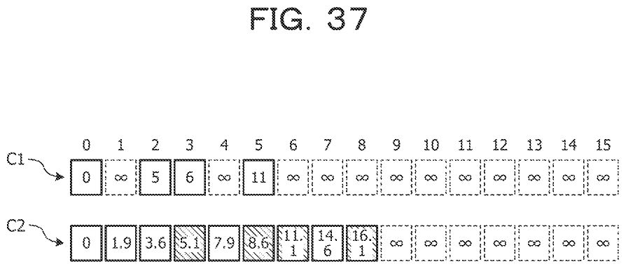

First, it is assumed that an existing array before the reflection be an array_a. FIG. 37 is a diagram illustrating an example of a data structure of array information according to the third embodiment. As illustrated in FIG. 37, a case C1 indicates an array_a before reflection and illustrates an example of an accepted order status (sell order). Specifically, for example, the array_a contains values such as a₀=0, a₁=∞, a₂=5, a₃=6, . . . .

An array_b of an order desired to be reflected (accepted sell order) is an array in which an amount of money that is paid (received in a case of buy order) at the time of purchasing n shares that is the number of orders is set to be bn. The setting units 152 and 252 of the information processing apparatuses 100 and 200 accept the array_b of the order (sell order/buy order) desired to be reflected and reflect the array_b to the existing array_a corresponding to the order status (sell order/buy order) through the convolution using the TACU algorithm.

It is assumed here that the information processing apparatuses 100 and 200 accept an order including an order condition in which prices at three stages are set depending on the number of orders, such that a price is equal to or more than 19,000 yen for one share, equal to or more than 36,000 yen for two shares, and equal to or more than 51,000 yen for three shares. In this case, the array_b is b₀=0, b₁=1.9, b₂=3.6, b₃=5.1 (other terms are set to ∞). Note that b₀=0 corresponds to not to execute.

The array cₖ after reflection using the TACU algorithm is convolution with the minimum values of aₙ and bₙ. A case C2 in FIG. 37 indicates a result (array cₖ) of convolution with the minimum values of aₙ and bₙ described above.

For example, the setting units 152 and 252 of the information processing apparatuses 100 and 200 obtain c₃ as follows through the convolution with the minimum value using the TACU algorithm.

c₃=min{a₀+b₃,a₁+b₂,a₂+b₁,a₃+b₀}=min{5.1, ∞, 6.9, 6}=5.1

Although the convolution calculation with the minimum value (maximum value in a case of buy order) normally needs a calculation amount of o (n²), only a calculation amount of 0 (nlogn) is needed using the TACU algorithm.

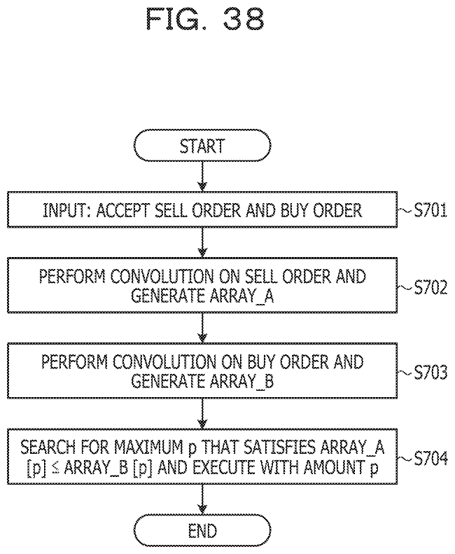

FIG. 38 is a flowchart illustrating a processing procedure of an information processing apparatus according to the third embodiment. As illustrated in FIG. 38, the acquisition unit 151 (251) of the information processing apparatus 100 (200) accepts inputs of sell orders and buy orders (S701).

Next, the setting unit 152 (252) performs the above convolution (array update processing) on the accepted sell orders and generates an array array_A (first array information 143 (243)) (S702).

Next, the setting unit 152 (252) performs the above convolution (array update processing) on the accepted buy orders and generates an array array_B (second array information 144 (244)) (S703).

Next, the order specification unit 154 (254) searches for the maximum p that satisfies array_a [p]≤array_b [p] by the processing for specifying orders to be executed described above and specifies executions with an amount p (S704).

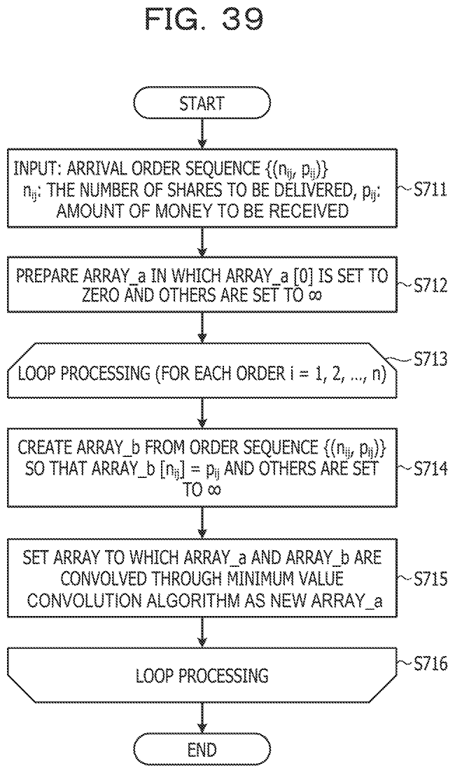

FIG. 39 is a flowchart illustrating a processing procedure of the array update processing of sell orders according to the third embodiment. Specifically, for example, FIG. 39 illustrates a processing procedure of the setting unit 152 (252) that generates the array_A in S702 in FIG. 38. Note that, in the following description, the description of the setting unit 252 will be omitted.

As illustrated in FIG. 39, when the processing is started, the setting unit 152 accepts an input of an arrival order sequence {(nᵢⱼ, pᵢⱼ)} corresponding to the accepted sell orders (S711). Here, nᵢⱼ indicates the number of shares to be delivered. Furthermore, pᵢⱼ indicates an amount of money to be received.

Next, the setting unit 152 prepares an array (existing array) array_a in which array_a [0] is set to zero and other elements are set to ∞ (S712). Next, the setting unit 152 executes loop processing in S713 to S716 on each order of the arrival order sequence (i=1, 2, . . . , n).

Specifically, for example, the setting unit 152 creates the array_b from the order sequence {(nᵢⱼ, pᵢⱼ)} so that array_b [nᵢⱼ]=pᵢⱼ and other elements are set to ∞ (S714). Next, the setting unit 152 obtains an array to which the array_a and the array_b are convolved through minimum value convolution using the TACU algorithm. Next, the setting unit 152 sets the array obtained in this way, that is, for example, the existing array corresponding to the status in which the sell orders are combined as a new array_a (S715).

Following the loop processing in S713 to S716, the setting unit 152 sets the obtained array_a as the array_A (first array information 143) to which all the accepted sell orders are reflected and ends the processing.

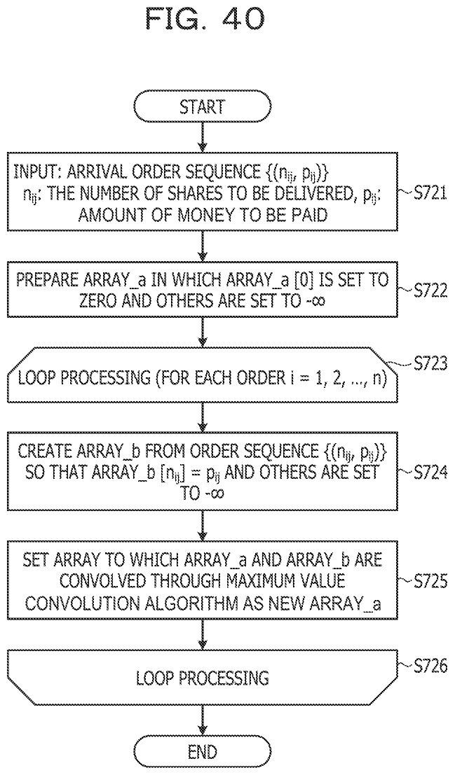

FIG. 40 is a flowchart illustrating a processing procedure of the array update processing of buy orders according to the third embodiment. Specifically, for example, FIG. 40 illustrates the processing procedure of the setting unit 152 (252) that generates the array_B in S703. Note that, in the following description, the description of the setting unit 252 will be omitted.

As illustrated in FIG. 40, when the processing is started, the setting unit 152 accepts an input of an arrival order sequence {(nᵢⱼ, pᵢⱼ)} corresponding to the accepted buy orders (S721). Here, nᵢⱼ indicates the number of shares to be delivered. Furthermore, pᵢⱼ indicates an amount of money to be paid.

Next, the setting unit 152 prepares an array (existing array) array_a in which array_a [0] is set to zero and other elements are set to −∞ (S722). Next, the setting unit 152 executes loop processing in S723 to S726 on each order of the arrival order sequence (i=1, 2, . . . , n).

Specifically, for example, the setting unit 152 creates the array_b from the order sequence {(nᵢⱼ, pᵢⱼ)} so that array_b [nᵢⱼ]=pᵢⱼ and other elements are set to −∞ (S724). Next, the setting unit 152 obtains an array to which the array_a and the array_b are convolved through maximum value convolution using the TACU algorithm. Next, the setting unit 152 sets the array obtained in this way, that is, for example, the existing array corresponding to the status in which the buy orders are combined as a new array_a (S725).

Following the loop processing in S723 to S726, the setting unit 152 sets the obtained array_a as the array_B (second array information 144) to which all the accepted buy orders are reflected and ends the processing.

As described above, the information processing apparatuses 100 and 200 set information based on an order sequence and the number of orders regarding orders to an array. The information processing apparatuses 100 and 200 convolve an array corresponding to an order condition in which prices at multiple stages are set depending on the number of orders with respect to the set array using the TACU algorithm. As a result, the information processing apparatuses 100 and 200 may perform the convolution with the calculation amount of O (nlogn), and it is possible to reduce a calculation cost.

The information processing apparatuses 100 and 200 convolve the array corresponding to the order condition with respect to the array set to sell orders under the condition for adopting the minimum value, using the TACU algorithm. As a result, the information processing apparatuses 100 and 200 may obtain the array regarding the sell orders with the calculation amount of O (nlogn).

The information processing apparatuses 100 and 200 convolve the array corresponding to the order condition with respect to the array set to buy orders under the condition for adopting the maximum value, using the TACU algorithm. As a result, the information processing apparatuses 100 and 200 may obtain the array regarding the buy orders with the calculation amount of O (nlogn).

Note that each of the illustrated components in each of the devices is not necessarily physically configured as illustrated in the drawings. In other words, for example, the specific aspects of distribution and integration of the respective devices are not limited to the illustrated aspects, and all or some of the devices may be functionally or physically distributed and integrated in any unit in accordance with various loads, use status, and the like.

A case has been described where each embodiment described above is applied to a case where an order is placed under conditions such as full-volume execution or a certain number of orders in share transactions in the securities market. However, the application is not limited to the application to the share transactions. For example, this case may be applied to transactions in the futures-transactions market or the like other than stock transactions.

Various processing functions executed by the information processing apparatuses 100 and 200 may be entirely or optionally partially executed by a CPU (or microcomputer such as MPU or micro controller unit (MCU)) or a graphics processing unit (GPU). Furthermore, all or some of the various processing functions may of course be executed by a program to be analyzed and executed by a CPU (or microcomputer such as MPU or MCU) or a GPU or hardware using wired logic. Furthermore, various processing functions executed with the information processing apparatuses 100 and 200 may be executed by a plurality of computers in cooperation through cloud computing.

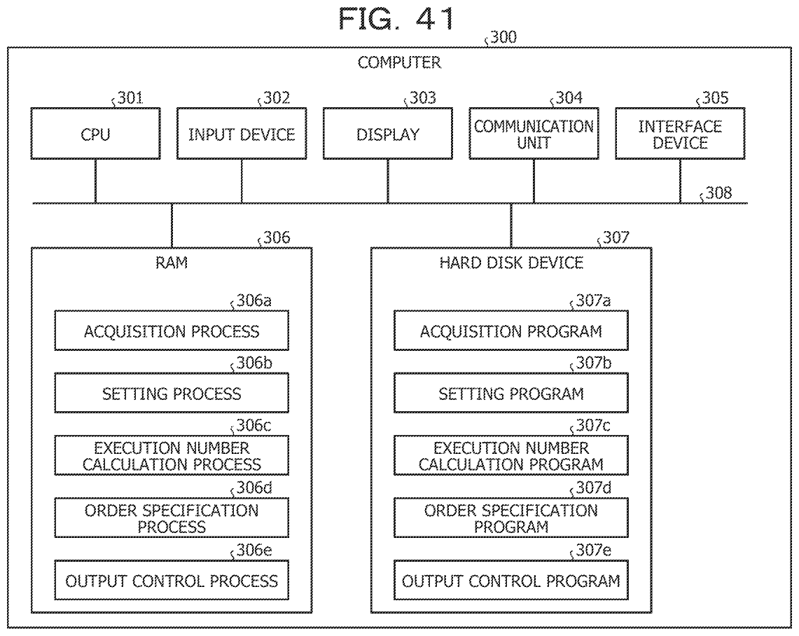

Next, an exemplary hardware configuration of a computer that implements functions similar to those of the information processing apparatus 100 (200) described in the embodiments described above will be described. FIG. 41 is a diagram illustrating an exemplary hardware configuration of the computer that implements the functions similar to those of the information processing apparatus 100 (200) according to the embodiments.

As illustrated in FIG. 41, a computer 300 includes a CPU 301 that executes various types of operation processing, an input device 302 that accepts data input from a user, and a display 303. Furthermore, the computer 300 includes a communication device 304 that exchanges data with an external device or the like via a wired or wireless network and an interface device 305. Furthermore, the computer 300 includes a RAM 306 which temporarily stores various types of information and a hard disk device 307. Then, each of the devices 301 to 307 is coupled to a bus 308.

The hard disk device 307 includes an acquisition program 307a, a setting program 307b, an execution number calculation program 307c, an order specification program 307d, and an output control program 307e. Furthermore, the CPU 301 reads each of the programs 307a to 307e, and loads it to the RAM 306.

The acquisition program 307a functions as an acquisition process 306a. The setting program 307b functions as a setting process 306b. The execution number calculation program 307c functions as an execution number calculation process 306c. The order specification program 307d functions as an order specification process 306d. The output control program 307e functions as an output control process 306e.

The processing of the acquisition process 306a corresponds to the processing of the acquisition units 151 and 251. The processing of the setting process 306b corresponds to the processing of the setting units 152 and 252. The processing of the execution number calculation process 306c corresponds to the processing of the execution number calculation units 153 and 253. The processing of the order specification process 306d corresponds to the processing of the order specification units 154 and 254. The processing of the output control process 306e corresponds to the processing of the output control units 155 and 255.

Note that each of the programs 307a to 307e may not need to be stored in the hard disk device 307 beforehand. For example, each of the programs is stored in a“portable physical medium” to be inserted in the computer 300, such as a flexible disk (FD), a compact disc read only memory (CD-ROM), a digital versatile disc (DVD), a magneto-optical disk, or an IC card. Then, the computer 300 may read and execute each of the programs 307a to 307e. Furthermore, each of the programs 307a to 307e may be stored in an external device coupled to a network such as a public line, the Internet, or a local area network (LAN), and the computer 300 may read each of the programs 307a to 307e from the external device coupled to the network and execute the programs.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an execution program for causing a computer to execute a process, the process comprising:
setting information based on an order sequence and a number of orders regarding an order to a first array; and
convolving a second array that corresponds to an order condition in which prices at multiple stages are set depending on the number of orders to the first set array using a Try-And-Clean-Up (TACU) algorithm.

2. The non-transitory computer-readable recording medium according to claim 1, wherein
the order is a sell order, and
the process further comprises:
convolving the second array to the first array using the TACU algorithm under a condition in which a minimum value is adopted.

3. The non-transitory computer-readable recording medium according to claim 1, wherein
the order is a buy order, and
the process further comprises:
convolving the second array to the first array using the TACU algorithm under a condition in which a maximum value is adopted.

4. An execution method, comprising:
setting, by a computer, information based on an order sequence and a number of orders regarding an order to a first array; and
convolving a second array that corresponds to an order condition in which prices at multiple stages are set depending on the number of orders to the first set array using a Try-And-Clean-Up (TACU) algorithm.

5. The execution method according to claim 4, wherein
the order is a sell order, and
the process further comprises:
convolving the second array to the first array using the TACU algorithm under a condition in which a minimum value is adopted.

6. The execution method according to claim 4, wherein
the order is a buy order, and
the process further comprises:
convolving the second array to the first array using the TACU algorithm under a condition in which a maximum value is adopted.

7. An information processing apparatus, comprising:
a memory; and
a processor coupled to the memory and the processor configured to:
set information based on an order sequence and a number of orders regarding an order to a first array; and
convolve a second array that corresponds to an order condition in which prices at multiple stages are set depending on the number of orders to the first set array using a Try-And-Clean-Up (TACU) algorithm.

8. The information processing apparatus according to claim 7, wherein
the order is a sell order, and
the processor is further configured to:
convolve the second array to the first array using the TACU algorithm under a condition in which a minimum value is adopted.

9. The information processing apparatus according to claim 7, wherein
the order is a buy order, and
the processor is further configured to:
convolve the second array to the first array using the TACU algorithm under a condition in which a maximum value is adopted.
